(19) United States
(12) Patent Application Publication
(10) Pub. No.: US 2025/0191491 A1
(43) Pub. Date: Jun. 12, 2025

(54) MODULAR RECONFIGURABLE SIMULATOR

(71) Applicant: VRgineers, Inc., Dover, DE (US)

(72) Inventors: Marek Polcak, Brno (CZ); Martin Chloupek, Chrastany (CZ); Antonin Posusta, Prague (CZ); Milan Kostilek, Nova Role (CZ); Samuel Ondruska, Prague (CZ); Jan Bzonek, Slatina (CZ)

(21) Appl. No.: 18/954,084

(22) Filed: Nov. 20, 2024

Related U.S. Application Data
(60) Provisional application No. 63/601,158, filed on Nov. 20, 2023.

(51) Int. Cl. G09B 9/16; G06F 3/01; G06T 7/20; G06T 7/593; G06V 20/20; G06V 40/10; G06V 40/20; G09B 9/30

(52) U.S. Cl. CPC G09B 9/165; G06F 3/011; G06F 3/017; G06T 7/20; G06T 7/593; G06V 20/20; G06V 40/10; G06V 40/28; G09B 9/302; G09B 9/307; G06T 2207/10012; G06T 2207/10028; G06T 2207/30196

(57) ABSTRACT

A Modular Reconfigurable Simulator is provided. The Modular Reconfigurable Simulator may include at least one Core Module with at least one Instrumental Module, including Computing Unit and Virtual or Mixed Reality headset. The Modular Reconfigurable Simulator may be reconfigured into multiple different aircraft by the user without needing additional technical assistance from a third party while emulating aircraft ergonomics and automatically binding controller functions with Image Generators virtual aircraft model.

### CROSS-REFERENCE TO RELATED APPLICATION

The present application claims priority to U.S. Provisional Patent Application No. 63/601,158, filed Nov. 20, 2023, which is incorporated herein by reference in its entirety.

### TECHNICAL FIELD

The disclosure relates generally to the field of flight simulators, and specifically and not by way of limitation; some embodiments are related to reconfigurable flight simulators.

### BACKGROUND

The aerospace industry has been leading simulation technology progress since the invention of aircraft. This is given by the combination of training complexity required to operate an airplane, risks connected with any mismanagement, and the actual cost of the aircraft.

Over the last fifty years, the simulation industry evolved from zero to a comprehensive, regulated market segment. The existence of precise specifications of different simulator standards by regulatory agencies such as EASA (in Europe) or FAA (in the United States of America) enhances the importance of pilot training and the sophistication of simulators.

Currently, we can find a variety of simulators on the market, from non-certified Components Off-The-Shelf (COTS) simulators made by hobby pilots to the most sophisticated and realistic Level D simulators made out of real aircraft components, including instrumental panels. Two main attributes define standard simulators: what they simulate and which visualization system is used.

A standard simulator simulates one specific aircraft type, such as a Boeing 737-800, or a group of aircraft, such as single-engine propeller aircraft. This limitation is given by the different shapes of cockpits, different instrumental panels, and their position, which is unique for each manufacturer and airplane.

Standard simulators use data projection or LCD panels connected to one or more computers, which provide computer graphics visualization. Graphics are generated by special image generator (IG) software, a common name for any simulation software. Any existing standard simulator can be enhanced by connecting virtual or mixed-reality headsets. However, a complicated integration process may need to make virtual or mixed reality (VR/MR) compatible.

These standard simulators are being manufactured by OEM (Original Equipment Manufacturer), transported to the client's location, and assembled by the OEM technicians. Suppose the client requests to modify the simulator for different aircraft versions. In that case, it can be done by exchanging a particular part of the cockpit, primarily by OEM technicians, or by manufacturing the whole cockpit again with requested modifications. It is not possible to change between different groups of airplanes without a significant effort and NRE (Non-Recurring-Engineering) from the OEM.

When the simulator is being delivered and installed, technical specialists with appropriate know-how execute the installation. This applies to the on-site assembly, maintenance, and service tasks.

This may be given by the simulator design approach and the simulator's technological limitations, which were significantly influenced by the requirements of the visualization system. The visualization system requires the construction of mounts for LCD screens or dome projection canvases. This equipment may need a lot of electricity and emits considerable heat, which must be managed by controlled air conditioning. Due to these requirements, there was no need to focus on portability, power consumption, and footprint of the actual simulator because buildings were specifically dedicated and modified to support any required equipment. This common approach influenced the physical construction of simulators, designed to be replicas of actual aircraft cockpits.

For standard projector-based and screen-based simulators, typical limitations:
They are built to simulate a specific aircraft model or a class of specific aircraft.
The cockpit dimensions are not limited, and the cockpit is mainly designed as one solid structure
The simulator is installed in a dedicated building with custom infrastructure tailor-made for simulator requirements (big entrance doors, air conditioning, power grid connection)
This simulator is perfectly aligned with a data-projection or screen support structure
The power consumption of a standard simulator is given by its equipment and, if needed, without the ecological footprint in mind.

As mentioned, these simulators can be upgraded by connecting a virtual or a mixed-reality headset. However, such an upgrade does not remove their limitations or make them fully functional. To harness the potential of virtual and mixed reality as a medium for training, it may be necessary to invent a new solution that is built bottom-up, removing the technological obstacles, making every part of such a complex system its integral part, including cockpit, the computer, headset as well as advanced algorithms.

### SUMMARY

A system of one or more computers can be configured to perform particular operations or actions by virtue of having software, firmware, hardware, or a combination of them installed on the system that in operation causes or cause the system to perform the actions One or more computer programs can be configured to perform particular operations or actions by virtue of including instructions that, when executed by data processing apparatus, cause the apparatus to perform the actions. One general aspect includes a Modular Reconfigurable Simulator (MRS) system for flight training. The MRS also includes a Core Module (CM) with a user seat; a plurality of interchangeable Instrumental Modules (IM) designed to replicate cockpit control interfaces of various aircraft types, including fixed-wing, rotary-wing, and drones; a mechanism for easily exchanging each of the plurality of interchangeable IMs by a user to transform the MRS to simulate different aircraft types; integrated support for Virtual and Mixed Reality (VR/MR) headsets to provide immersive simulation environments; and a Computing Unit (CU) containing software to recognize and integrate the plurality of interchangeable IMs with a virtual model of an aircraft cockpit, where each IM includes a set of controls corresponding to specific aircraft functions and a unique identification system for automatic recognition and configuration by the CU. Other embodiments of this aspect include corresponding computer systems, apparatus, and computer programs recorded on one or more computer storage devices, each configured to perform the actions of the methods.

One general aspect includes the Mixed Reality (MR) Simulation Architecture also includes a computer hardware system including a Field-Programmable Gate Array (FPGA) and a Graphical Processing Unit (GPU); a Virtual Reality (VR) headset equipped with a stereo camera module; a software framework configured to process real-time video streams captured by the VR headset and render virtual environments using the GPU; an algorithm set for optimizing color dynamic range, image debayering, denoising, and sharpening in video streams of the VR headset; a latency compensation mechanism that utilizes direct memory access of the FPGA to reduce processing delays; and an image compositing module that combines VR environment data and processed video streams to create a mixed reality output. Other embodiments of this aspect include corresponding computer systems, apparatus, and computer programs recorded on one or more computer storage devices, each configured to perform the actions of the methods.

One general aspect includes a Virtual Reality Cockpit Handtracking (VRCH) system. A VRCH system may include an array of optical sensors for detecting hand and finger movements, a processing unit configured to create a 3D model of user's hand movements in real-time, a software application capable of interpreting the 3D model to simulate user interactions with virtual cockpit controls, an integration interface for connecting the hand-tracking system with various VR simulation environments, and a machine learning algorithm to improve hand and finger tracking accuracy based on user interactions. Other embodiments of this aspect include corresponding computer systems, apparatus, and computer programs recorded on one or more computer storage devices, each configured to perform the actions of the methods.

One general aspect includes a Mixed Reality Cockpit Handtracking (MRCH) system. An MRCH system for simulator training may include multiple image sensors (cameras) placed in the headset; a central processing system configured to detect and cut out hands and fingers from the images; a real-time rendering module to overlay detected hands and fingers onto a mixed reality visual output; a calibration system for aligning sensor data with virtual cockpit controls; and customizable algorithms to accommodate various cockpit layouts and control configurations. Other embodiments of this aspect include corresponding computer systems, apparatus, and computer programs recorded on one or more computer storage devices, each configured to perform the actions of the methods.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes an Automatic Tracking Setup (ATS). An ATS system for Virtual and Mixed Reality environments may include an array of tracking sensors for establishing a coordinate space within a simulated environment; a Computing Unit (CU) with software capable of synchronizing the tracking sensor data with a virtual environment; a calibration mechanism utilizing unique visual codes within the environment for precise spatial orientation; a feature for continuous real-time positional correction based on predefined calibration patterns; and a user interface for facilitating the initial setup and ongoing adjustments to the tracking system. Other embodiments of this aspect include corresponding computer systems, apparatus, and computer programs recorded on one or more computer storage devices, each configured to perform the actions of the methods.

One general aspect includes a Drone Remote Training (DRT). A DRT system may include a MRS equipped with controls replicating aircraft operation; a Mixed Reality (MR) headset capable of displaying real-time video streams from a drone; a drone equipped with a camera and an MR module, operable via remote control; a network connection system for transmitting control signals and video data between the MRS and the drone; an image generator within the MRS for simulating flight scenarios and integrating real-time drone video feeds; and a synchronization mechanism for aligning the user's head movements with the camera orientation on the drone, providing a first-person view experience. Other embodiments of this aspect include corresponding computer systems, apparatus, and computer programs recorded on one or more computer storage devices, each configured to perform the actions of the methods.

This summary and the following detailed description are merely exemplary, illustrative, and explanatory and are not intended to limit but to provide further explanation of the invention as claimed. Other systems, methods, features, and advantages of the example embodiments will be or will become apparent to one skilled in the art upon examination of the following figures and detailed description.

### BRIEF DESCRIPTION OF THE FIGURES

FIG. 1 illustrates an example MSR configuration which includes one Core Module (CM) and three Instrumental Modules (IM), one mounted on the left side of the simulator, one mounted on the center of the simulator, and one mounted on the right side of the simulator. (e.g., F-35 Lightning II)

FIG. 2 illustrates an example MSR configuration for a two-seat aircraft with separate seat locations: this setup allows training in the same or remote location in the same virtual environment. (e.g., F-18 SuperHornet)

FIG. 3 illustrates an example MSR configuration for a two-seat aircraft with connected seats in the same location (e.g., Airbus 320)

FIG. 4 illustrates an example MSR configuration for a two-seat aircraft example with connected seats and no side modules in the same location (e.g., Sikorsky UH-60 helicopter)

FIG. 5 illustrates the Core Module (CM) parts and the CM's design, which may provide versatility and capability to emulate any cockpit ergonomics.

FIG. 6 illustrates an example of MSR-specific parts of a mechanical pedal platform.

FIG. 7 illustrates an example of MSR-specific parts of an electromechanical pedal platform.

FIGS. 8A-8C illustrate an example of mechanical design features that allow the seat to emulate the ergonomics of any existing cockpit.

FIG. 9 illustrates an example IM, which is mounted on the front of the Core Module (CM) and includes various controllers.

FIGS. 10A-10B illustrate an example of Instrumental Modules (IM), which are mounted on the sides of Core Module (CM) and include various controllers.

FIGS. 11A-11F illustrate an example of different Instrumental Modules (IM) of aircraft mounted on the Core Module (CM), showing its reconfigurability.

FIGS. 12A-12C illustrate an example schematics of the hardware-firmware-software solution, which was specifically invented to make MRS conveniently reconfigured by users without needing external technical support.

FIG. 13 illustrates an example of Mixed Reality Simulator Architecture (MSA), including Mixed Reality headset, connected via optical or hybrid (optics with metallic) cables to a FPGA connected to GPU.

FIG. 14 illustrates an advanced image processing algorithms increasing mixed reality's overall picture quality and fidelity of MSA, which decreases the mixed reality system latency and optimizes its performance distribution.

FIGS. 15A-15B illustrate a misalignment of virtual and mixed reality of existing systems.

FIG. 16 illustrates an example of a method (algorithm) for correct virtual and mixed reality alignment

FIG. 17 illustrates a Modular Reconfigurable Simulator setup with a Mixed Reality headset using correct virtual and mixed reality alignment method (algorithm).

FIGS. 18A-18E illustrate an example of the most common ways to interact with simulators using currently available technologies.

FIGS. 19A-19D illustrate an example of Virtual Reality Cockpit Hand Tracking (VCH), represented by a functional interconnected array of precisely calibrated hand-tracking sensors combined with a data merging algorithm used in a MRS cockpit.

FIG. 20 illustrates an example of the Mixed Reality Cockpit Hand Tracking (MCH) system using additional overlays and filters.

FIG. 21 illustrates a first-person view of a MRS using Mixed reality Cockpit Hand tracking (MCH).

FIGS. 22A-B illustrate an example of differences in ambient lightning of virtual reality and real environment represented by mixed image, which disrupts the immersion in existing mixed reality simulators.

FIG. 23 illustrates an example of a Realistic Cockpit Lightning (RCL) system, a system including a hardware-software solution, emulating simulated lightning in the MRS cockpit

FIG. 24 illustrates an example of hardware-software solution for remote operations of drone using Virtual reality or Mixed Reality headset combined with real-time video streams from a drone called Drone Remote Training (DRT).

### DETAILED DESCRIPTION

The following disclosure describes various embodiments of the present invention and method of use in at least one of its preferred, best-mode embodiments, further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described concerning any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

The following description and the figures identify elements with reference numerals. The use of “e.g.,” “etc.,” and “or” indicates non-exclusive alternatives without limitation unless otherwise noted. The use of “including” or “includes” means “including, but not limited to,” or “includes, but not limited to,” unless otherwise noted.

Some embodiments relate to flight simulators, a complex system of interconnected hardware and software emulating cockpit and its functions of a real aircraft utilizing capabilities of Virtual and Mixed Reality (VR/MR) for simulation visualization, implementing advanced integration methods and combined software-hardware features enabling the user to reconfigure the simulator for variety of different airplanes including fixed-wing, rotary-wing, and drones.

Some embodiments include a MRS. Various embodiments may make virtual and mixed-reality simulators more realistic and efficient for any training scenario. Some aspects may focus on a definition based on its usage for rotary-wing and fixed-wing pilots. However, some embodiments may successfully be used for any simulator where human-to-machine interaction is desirable.

Some embodiments of MRS combine intelligent mechanical design, which covers the physical chassis of the modular, reconfigurable simulator, with a system of electronic hardware and software called automatic hardware setup (AHS). MRS always includes at least one Core Module (CM) with a user seat and one or more Instrumental Modules (IM) with cockpit controllers. Instrumental Modules can be easily exchanged by the user, changing the MRS from one aircraft type to another.

In some embodiments, the unique identification system may include a hardware-based identification mechanism integrated into each IM. Each IM may include a unique identifier stored on, for example, a custom microcontroller or other device. Upon connection to the Core Module (CM), the Computing Unit may read the identifier and automatically configure the module's functionality using pre-stored configuration files. The identifier may facilitate seamless module recognition and ensure compatibility with the Modular Reconfigurable Simulator (MRS) system.

Some embodiments of AHS include a mixture of custom-developed printed circuit boards (PCBs) together with firmware that runs on PCBs' micro processors and software applications that run on a connected computer. This set of programs automatically detects which instrumental modules (IM) are connected to the computer. Each PCB contains a unique identification (ID) with specific information about its controllers, such as the number of switches, trims, types of buttons, and relevant information needed to properly connect IPs with an image generator's virtual airplane model on a connected computer.

Some embodiments include fully integrating Virtual or Mixed-reality headsets and a set of defined software, firmware, and hardware functions specifically invented for simulations. This set includes Mixed reality Simulator Architecture (MSA) with its software pipeline, Cockpit Motion Compensation (CMC), Realistic Cockpit Lightning (RCL), Virtual reality Cockpit Handtracking (VCH), and Mixed reality Cockpit Handtracking (MCH)

In some embodiments, the MSA may represent a set of specific computer hardware components architecture together with a definition of algorithm calculations performed on this hardware to achieve the best performance and smooth functionality of mixed reality within any simulator.

In some example embodiments, the MSA optimizes simulation performance by leveraging field-programmable gate arrays (FPGAs) and graphics processing units (GPUs) configured to process visual and haptic data streams in parallel. The example architecture may reduce latency by employing predictive rendering algorithms, which pre-process simulation data to minimize frame delays. Benchmark tests have demonstrated latency reductions of up to 20 milliseconds compared to conventional VR/MR systems, ensuring real-time synchronization of virtual and physical environments. It will be understood that other embodiments may include other embodiments may use one or more of FPGAs, GPUs, Application-Specific Integrated Circuits (ASICs), Digital Signal Processors (DSPs), Tensor Processing Units (TPUs), Neural Processing Units (NPUs), microcontrollers (MCUs), Reduced Instruction Set Computing (RISC) processors, Field-Programmable Analog Arrays (FPAAs), Systems-on-Chip (SoCs), Coarse-Grain Reconfigurable Architectures (CGRAs), and Vision Processing Units (VPUs).

In some embodiments, the MSA emphasizes latency reduction to enhance responsiveness in VR/MR simulations. By uniquely integrating a FPGA (or other custom hardware device) with a GPU, the system allows for direct memory access between the FPGA and GPU, which bypasses traditional CPU processing bottlenecks. This design reduces latency by multiple milliseconds, achieving near-instantaneous processing times crucial for realistic simulation. Image optimization algorithms, such as custom debayering and dynamic color adjustment, operate directly on the FPGA to deliver high-fidelity visuals without compromising processing speed. This configuration may provide enhanced realism and immersive quality by responding instantly to user actions, addressing challenges in VR/MR latency and simulation fidelity.

In some embodiments, the MSA includes a robust hardware-software configuration designed to deliver seamless VR/MR environment transitions by employing an FPGA-GPU combination for real-time video processing. The MSA integrates video feeds from the VR headset's stereo camera module with advanced algorithms on the FPGA that perform image enhancements, including dynamic color range adjustment, sharpening, and debayering. By utilizing direct memory access (DMA) pathways, this configuration minimizes latency, ensuring that the virtual and mixed reality views are responsive to the user's actions. This efficient data handling allows for continuous frame rendering at high fidelity, essential for applications where realistic simulation feedback is necessary.

In some embodiments, MRS incorporates precise head tracking technology, which may be necessary to provide motion and rotation information of the user wearing a VR/MR headset to the image generator on the connected computer. Based on the detected motion and rotation of the user, IG renders the corresponding image, creating a virtual reality experience. CMC is a combination of hardware sensors embedded in a VR/MR headset or simulator itself, together with the sophisticated algorithm, compensating for a misalignment of position between the virtual reality camera in IG and the headset camera. CMC fixes this misalignment between virtual space and the real world, represented by a camera image of the cockpit, connecting these two environments into one coordinate system

Some embodiments may include one or more of the following benefits, including a well-executed mixed-reality simulation. The simulation may be fully immersive. Small details appearing to be different between virtual and mixed-reality scenes may cause a breach of immersion connected with the user's unrealistic feeling. One such situation happens when the lighting of the physical simulator is different than the lighting of the virtual cockpit rendered by IG. To match the lightning of a real cockpit and its virtual twin, we invented a Realistic Cockpit Lightning system, which is a set of algorithms providing a calculated value of cockpit ambient lightning, which is being sent to separately controllable LEDs embedded in MRS to provide well-distributed lightning to the physical cockpit.

In some embodiments, the Realistic Cockpit Lighting (RCL) system further enhances simulation immersion by dynamically adjusting physical cockpit lighting to match the virtual environment's visual conditions. This may be achieved through a Light Decomposition Algorithm and independently controlled LEDs positioned throughout the cockpit. The algorithm may continuously analyzes the virtual lighting within the cockpit environment generated by the Image Generator (IG) and modulates the physical LEDs in real-time, simulating changes in lighting such as transitions from day to dusk. This synchronization ensures that both physical and virtual lighting appear cohesive, significantly improving the user's ability to perceive cockpit details accurately in diverse lighting conditions for effective training.

Another aspect of some embodiments of human-to-machine systems may be hand interaction capability. Due to the distinction between virtual reality and mixed reality, different approaches and embodiments have been developed. In one embodiment, a Virtual reality Cockpit Handtracking (VCH) may allow users to operate virtual controllers in any virtual scene without any physical instruments. On the other hand, mixed reality Cockpit Handtracking (MCH) allows users to efficiently operate physical controls in the cockpit, which are part of a mixed reality scene. Each embodiment may be based on different technologies to provide precise handtracking, enabling users to operate any controls in any existing cockpit.

Some embodiments include a MRS, which provides a realistic simulation experience and includes at least two cockpit configurations with VR/MR visualization capacity.

Virtual Reality is a computer-generated image rendered from a location and under a specific angle, according to the measured position of the virtual reality headset tracking system, which can be optical, electromagnetically, or other. The picture is rendered on the highest possible resolution and frequency to deliver a smooth and fluent experience for the end user (the general public recommendation is 90 Hz). However, the tracking system is recommended to supply at least rotational information in frequency of hundreds of Hz to apply time-warping in a case that the computer cannot render on high enough frequency. The virtual image is only one layer, and we will refer to it as a background for purposes of Mixed Reality.

While using Mixed Reality, another layer of camera image is being visualized over the background (VR image), a real-time camera stream cutout. In most use cases, mixed reality scenes or objects are particular. The most common methods for their masking (seeing them and no other objects) are color masking or geometrical masking. Color masking allows setting color, which, when detected in the real-time video stream, becomes transparent, showing the background. The same applies to geometrical masking. However, the cutout area of the real-time video stream is given by a preset geometrical area. This area is defined in a virtual environment. Therefore, it does not move and is stationary thanks to its connection to tracking system information.

On top of these two layers, we developed a modular software system allowing us to add additional layers for specific use cases. The typical specific layer is the hand-cutout layer, projected over the background and video cutout. Another example of the specialized layer is night vision mode. This layer is applied atop the abovementioned layers and simulates night vision goggles first person view. The same applies also for Augmented Reality (AR) headset emulation. Modern jet fighters, helicopters, and other operators of complex machines are equipped with AR headsets embedded into pilots' helmets. Information projected on the AR helmet can be easily visualized using the top layer of our visualization rendering pipeline.

MRS cockpit configurations can be completely different airplanes (such as F-16 BLOCK 10 and A29B SuperTucano) or a different version of the same airplane, containing different instrumental panels (such as F-16 BLOCK 10 and F-16 BLOCK 50). Some embodiments may include a capability to be reconfigured by the end user/client on-site without needing OEM technical support. Some embodiments may contain multiple software-firmware-hardware aspects described herein and deliver a realistic, comfortable experience and enable reconfigurability.

MRS innovative design may cover currently existing cockpit ergonomics variations, which may be needed to avoid negative training. The precise position, shape, look, and feel of cockpit controls may be needed to train standard procedures, emergency procedures, and correct muscle memory. Muscle memory plays a significant role in executing learned procedures during critical, high-stress situations

Cockpit dimensions and controls within the cockpit must be in an exact position to enable cadets to learn correct muscle memory and avoid negative training patterns. Muscle memory cannot be trained using simplified simulators with touch screens instead of physical instruments.

MRS can be easily packed and moved anywhere, into any building with standard doors, because it is designed to be disassembled, transported, and assembled by non-technicians, similarly to self-assembled furniture (e.g., IKEA).

MRS is characterized by
It contains at least one Core Module (CM) and one IM
Multiple MRS can be connected using any computer network connection (e.g., Ethernet TCP/IP), creating a joint simulation environment for combined and multi-crew training.
It is designed to be mechanically adjusted to emulate any cockpit dimensions and ergonomics
It's designed to fit through a standard door and be carried by two people
It is designed to work using a standard power outlet per simulator seat, having a maximum consumption of 10A @ 110V/220V in standard configuration
Connected controllers are automatically recognized by the computer as a part of IM and mapped in IG

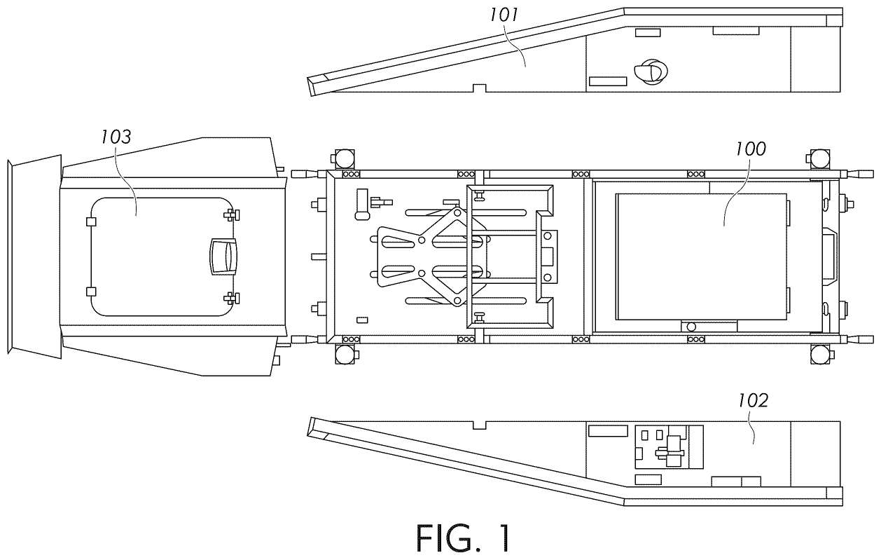

FIG. 1 illustrates a typical example configuration of an MRS, which contains one 100 Core Module (CM) and multiple Instrumental Modules (IM) 101, 102, and 103. An MRS cockpit with a frame and built-in electronics is called a core module (CM). In contrast, this frame can be fitted with multiple Instrumental Modules (IM), including a dashboard and side panels explicitly created for this frame, which truly replicates the cockpit environment of the desired aircraft type. This modular cockpit is combined with a headset for mixed reality, where the dashboard and two side panels represent the basic control elements of the cockpit, and the realistic space of the cockpit is drawn precisely by the mixed reality in the headset together with its actual physical design, which are fitted together by software. To interact with the cockpit, at least one IM may need to be installed and connected to the Core Module (CM).

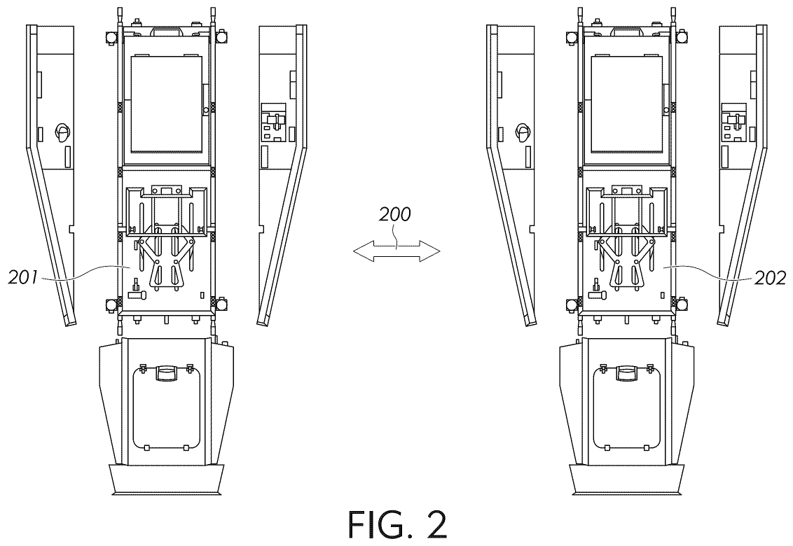

FIG. 2 illustrates an example of an MRS configuration for a two-seat aircraft. It includes a pilot configuration of the MRS 201, which includes the Core Module (CM) with three interconnected Instrumental Models (IM), which is connected using any network connection 200 (e.g., Ethernet TCP/IP) with co-pilot/gunner cockpit 202 which includes same or different Core Module (CM) with three interconnected Instrumental Models (IM). The number of Instrumental Modules (IM) used is determined by the aircraft type and requirements for specific training scenarios. To properly simulate cooperation between two interconnected MRS, any control in one of the interconnected cockpits, which can influence any control in the other cockpit, needs to have active force feedback capability. This especially applies to controllers such as Stick, Throttle, Cyclic, Collective, and Yoke, which are used most of the time to control the airplane, have specific feedback, and influence the controllers in the other cockpit.

The most common interface to communication between multiple simulators via LAN and WAN is Ethernet TCP/IP protocol. Computing Units of MRS are interconnected, exchanging information about the movement or change of position of any controller in real-time, streamed between the initiator of movement and the other user. Controllers may be equipped with active force feedback simulating realistic mechanical force. This is another characteristic differentiator against the standard simulators using data projection or screens, which have mechanically interconnected controllers. The electronic approach of MRS with separate mechanical force feedback for each participant allows them to operate remotely, with each MSR located in a different location and being visually connected using VR/MR. This approach allows more cost-efficient training when instructor pilots sit in a training location and connect remotely to users (cadets) in a different city, country, or continent. This approach also allows specialists to train remotely in countries and unreachable areas due to local transportation, humanitarian, political, or other situations. This system also includes an information exchange about the motion of MRS, controlling the connected motion platform and synchronizing the rotation and movement of interconnected MRS.

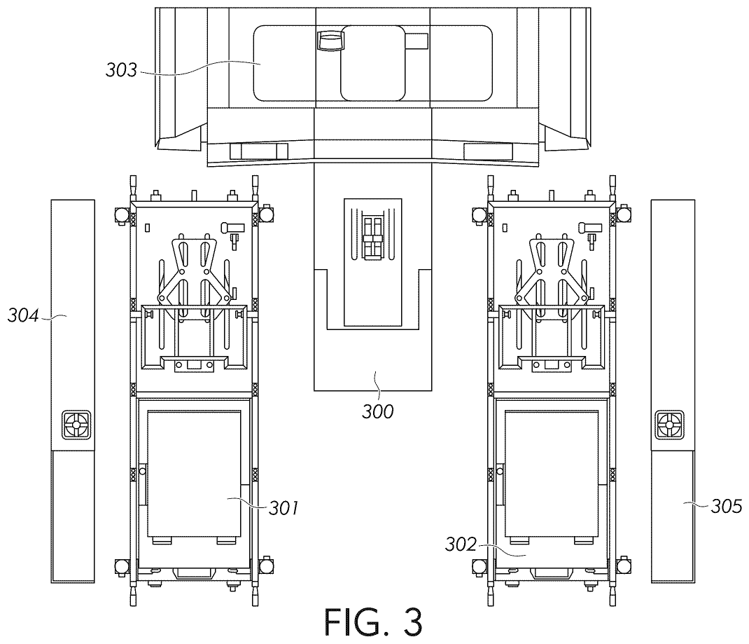

FIG. 3 illustrates an example of an MSR configuration for a two-seat aircraft with connected seats in the same location. It includes two Core Modules (CM) 301, 302 and two Instrumental Modules (IM) 304, 305 mounted on the sides of MRS and two Instrumental Modules (IM) 300, 303, mounted in the center of MRS. Each IM is unique, containing a specific set of switches, touchscreens, multifunctional displays (MFD), buttons, trims, and other controls as in the real cockpit of a specific type of aircraft that is being simulated.

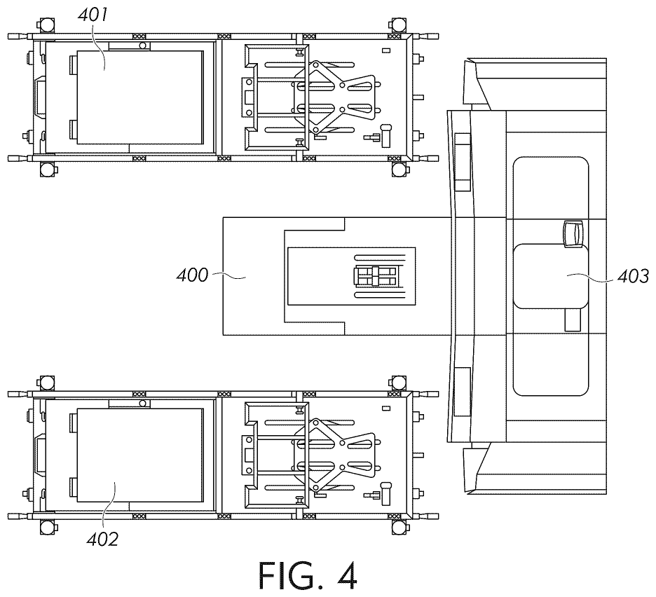

FIG. 4 illustrates an example of MSR configuration for a two-seat aircraft with connected seats and no side modules in the same location. In previous and this example of MSR configurations, such a setup can represent a rotary-wing or fixed-wing simulator. It includes two Core Modules (CM) 401, 402 and two Instrumental Modules (IM) 400, 403 mounted in the center of MRS.

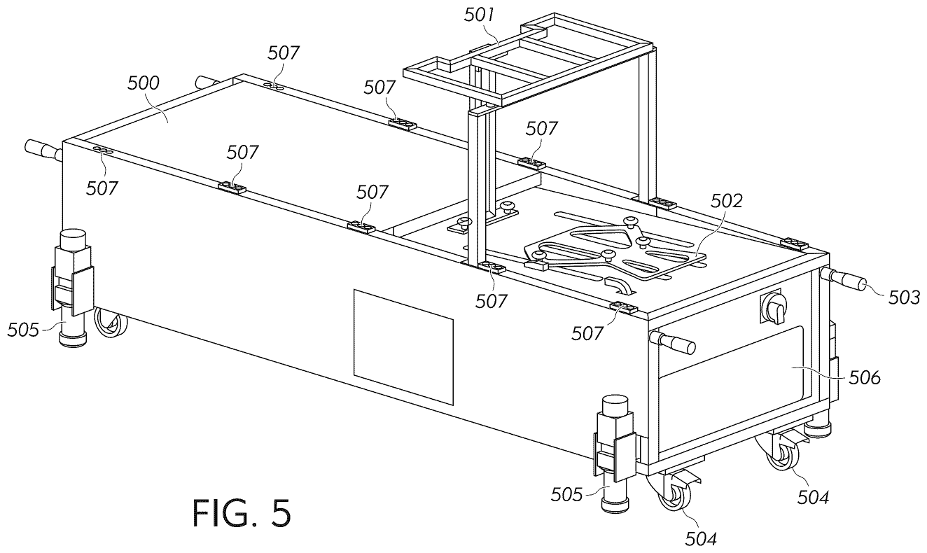

FIG. 5 illustrates details of the Core Module (CM) parts. The core module was designed as a universal building central block. The CM may be designed for its versatility and capability to emulate any cockpit ergonomics. Its design and multiple movable mounting platforms allow for a change in seating position and overall ergonomics for different aircraft. The system may include a 2-axes tilting and a back-and-forth moving platform 500 for the seat. In some embodiments, an optional folding table 501 may be provided, which is used as a mounting chassis for heavier Instrumental Modules (IM) of specific aircraft. Pedal platform 502 may allow motion in 1 axis, emulating an accurate adjustment of rudder pedals in aircraft. These features together enable MRS to cover any existing pilot seat in a helicopter, jetfighter, propeller, airliner, or any other aircraft or machine. The Central Modul mounts 500, 502, which may also allow seat and rudder pedals to be exchanged between different types to provide various options. Foldable handles 503 allow users to easily transport the MRS and 504 detachable wheels with brakes. When placed at the destination, MSR can stand on the floor using its detachable wheels (504) or fixed adjustable mechanical or dynamic adjustable electrical legs (505). Both types of legs allow the user to adjust the height of the simulator. Height adjustment allows the user to precisely align the pilot's eye-point against any external system. Electrical legs also allow MRS to simulate motion and provide additional vibration feedback to the user during the simulation.

A dedicated standardized 4U Rackmount 506 may be used to install one or more Computing Units (CU) into the RMS. The Computing Unit can be embedded in the RMS, or it can be placed outside of the simulator and connected using cables. The Computing Unit (CU) always contains a GPU for VR/MR headsets and Simulation Software (IG) with installed custom software to deliver RMS features. Central Module (CM) is also equipped with multiple mechanical joints 507, allowing simple connection of Instrumental Modules (IM). Joints can be used for static as well as dynamic purposes. The Instrumental Module is placed into these joints for static purposes, and installation is complete due to its gravitational fixating design. An additional pin is needed for dynamic purposes to fixate the IM, reinforcing the joint and fixating its movement in all directions, making it safe and secured while using RMS mounted on fast-moving motion platforms. The Central Module (CM) also includes a power delivery grid divided into two separate circuits. The first power delivery circuit supplies electricity to the Instrumental Modules (IM) and the electronics included in the Central Module (CM). The second power delivery circuit is dedicated to force feedback electric motors, e.g., electrical legs 505. The input of the MRS power delivery grid allows the connection of a 110-volt or 220-volt power source and is optimized to 10 Amperes.

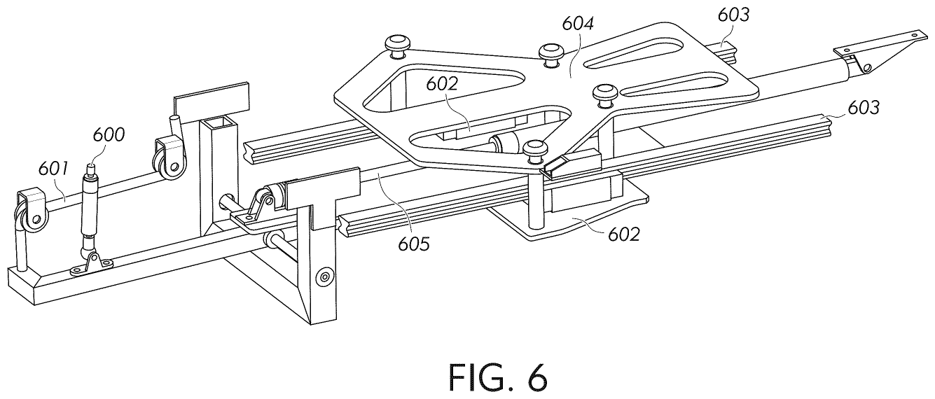

FIG. 6 illustrates specific parts of the mechanical pedal platform used in MSR. The pedal platform is mounted on two parallel linear guides 603, allowing linear carts 602 the movement. After releasing the lever, break cord 601 unlocks strut 600, allowing the user to move the pedal 604 mount within the range of motion. The backward movement is ensured by a spring 605 while moving the pedals forward requires using your legs to overcome the force of the spring 605 and thus moving the mounts 604 with pedals to the desired position.

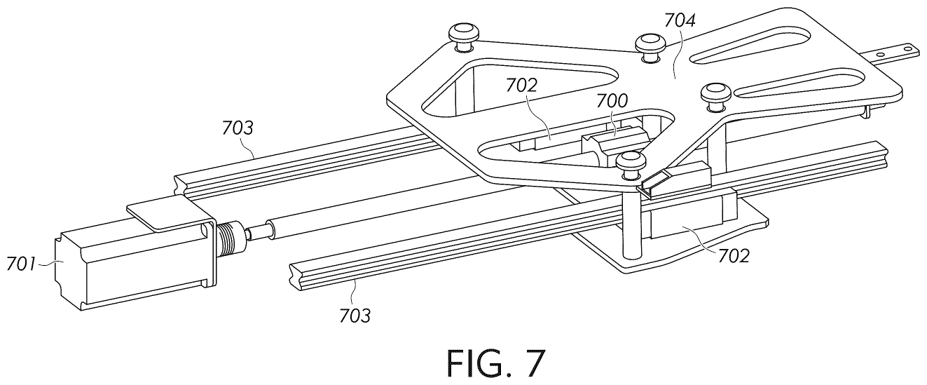

FIG. 7 illustrates specific parts of the electromechanical pedal platform used in MSR. The pedal platform is mounted on two parallel linear guides 703, allowing linear cart 702 the movement. The installed servo motor assembly 701 and the motion trapezoidal screw assembly 700 may be used for movement. The motion is activated by the user pressing the forward or backward button in one of the MSR Instrumental Modules (IM), moving the mount 704 with pedals to the desired position.

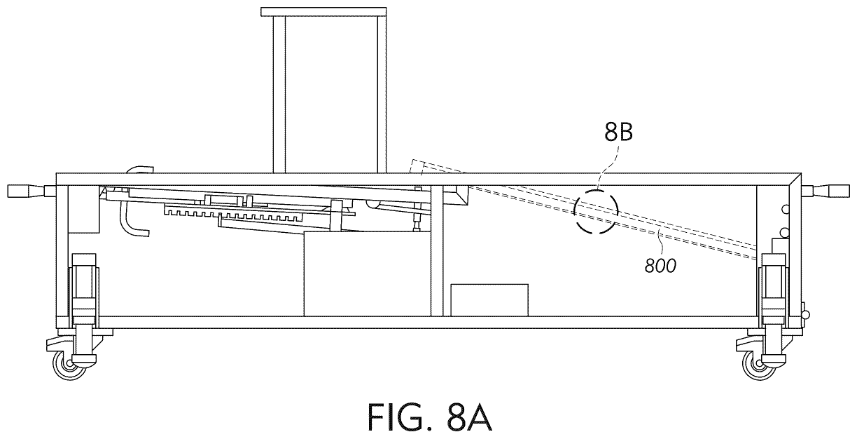

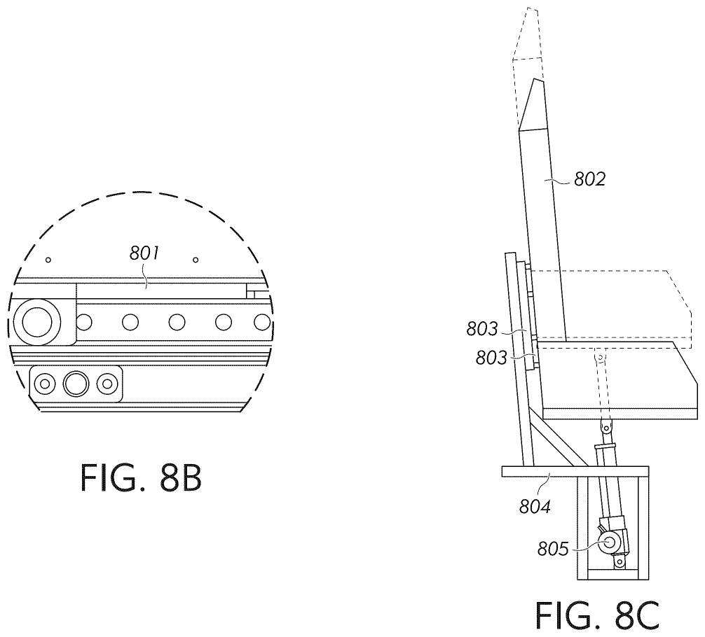

FIGS. 8A-8C illustrate mechanical design features allowing the seat to emulate the ergonomics of any existing cockpit. Seat platform mount 800 may be manually tilted to different angles, simulating tilt in different airplanes and machines. The vertical position of the seat can be manually adjusted as well, using a linear motion mechanism 801 with adjustable spikes. Another adjustable feature of the MRS design is an adjustable seat of 802 height. Linear rails 803 may hold the seat back to ensure safety, while electromotor 805 may lift seat 802 against main seat structure 804. These features may allow an MRS user to change the ergonomics in multiple coordinate systems and adjust dimensions as required, given the specifics of each aircraft (machine) by themselves.

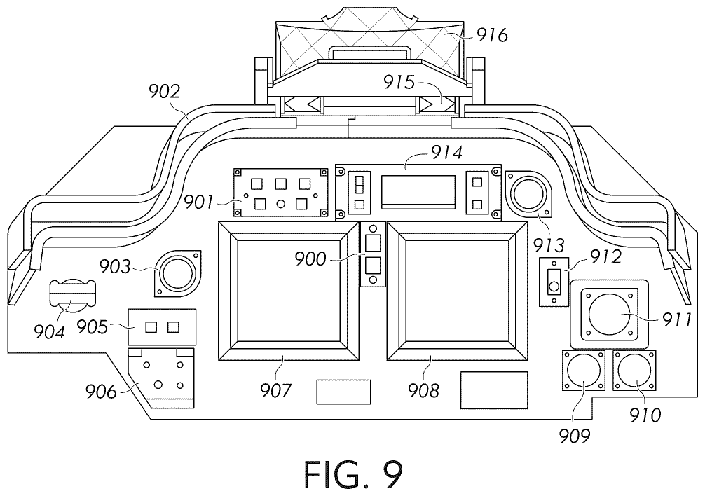

FIG. 9 illustrates an example of an Instrument Module (IM). This example shows the Instrumental Module, which is mounted on the front of the Core Module (CM) and includes various controllers. Instrumental Modules (IM) are designed to copy/replicate real cockpits or to fulfill specific requirements. This design presents an example of what such an IM can look like and which components are typically included. An IM is a construction representing a particular part of the cockpit with controls.

This particular example Instrument Module (IM) contains Master Warning 900, a signalization used in case of emergencies. In our example, the cockpit also includes fire detection panel 901, left air vent 903, canopy handle 904, which allows the user to close the canopy, armament panel 905, video panel 906, left multifunctional display (MFD) 907, and right multifunctional display (MFD) 908. On the right side of this example IM, we can find air speed indicator 909, barometric altimeter 910, Altitude indicator 911, master zeroing switch 912 and right air vent 913 and EUFD panel 914 showing various system and emergency messages combined with radio settings.

More or less of these human-to-machine interaction panels can be embedded. Each includes a variety of switches, buttons, levers, sliders, indicators, and displays or other controls. In addition to standard cockpit instruments, MRS incorporates a few specific parts. For easy entrance and exit of the MRS, the user can use handle 902, which is always part of one or more Instrumental Modules (IM). One of the Instrumental Modules (IM) also incorporates stand/mount/hook 916 for VR/MR headset, which is positioned in the user's reach, allowing him to operate MRS without the external need of the second person. One or more Instrumental Modules (IM) also incorporate an outside-in positional tracking system 915 if the connected VR/MR headset does not use inside-out positional tracking. Inside every IM, there may be one or more custom PCBs called Control Boards (CP). These connect the panels and controls and secure communication and information exchange with the Computing Unit. MRS for most small, single-seat aircraft includes three Instrumental Modules (IM): one mounted on the front of the Core Module (CM), another on the left side, and the last on the right side. MRS allows various configurations, including multi-crew cockpits with additional Instrumental Modules (IM) connecting two or more Central Modules or overhead Instrumental Modules (IM) positioned above the seated user.

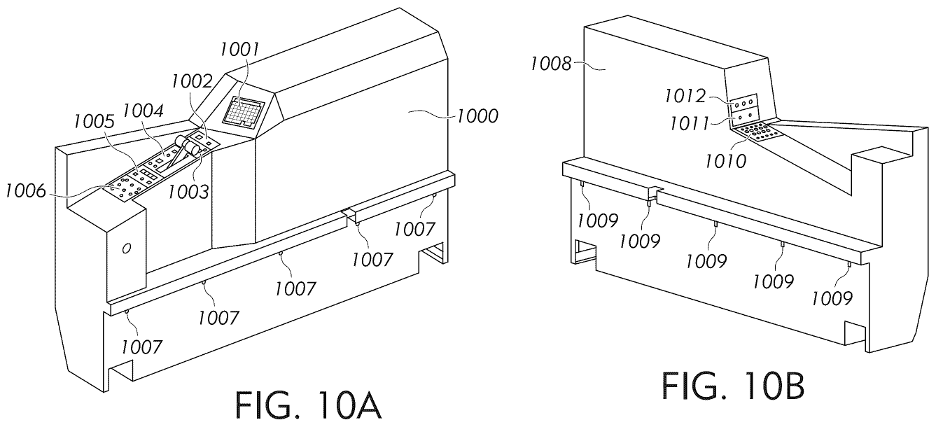

FIGS. 10A-10B illustrates an example of Instrumental Modules (IM), which are mounted on the sides of Core Module (CM) and include various controllers. The Left IM 1000 represents the left part of the aircraft cockpit. In this example configuration, it contains keypad 1001, rear wheel and National Airspace System Voice Switch (NVS) switch 1002, emergency system panel 1003, engine and Auxiliary Power Unit (APU) control 1004, Jettison panel 1005 and lightning panel 1006. An example of the right IM 1008 contains over-speed panel 1010, guarding the turbine, windshield wiper 1011, and communication panel 1012.

In addition to the panels mentioned above, 1000 left as well as right IM 1008 contains mounting pins 1007, 1009, which are used to physically connect Instrumental Modules (IM) with Core Module (CM).

Every IM, left IM 1000, as well as right IM 1008 may include a custom PCB called Control Boards (CP), which connects the panels and controls and secures communication and information exchange with the Computing Unit.

There can be an embedded variety of human-to-machine interaction panels. Each of them can include different or the same switches, buttons, levers, sliders, indicators, displays, or other controls. In addition to standard cockpit instruments, MRS Instrumental Modules (IM) being mounted on sides can incorporate foldable/bendable parts of its chassis to allow an accessible entrance and exit of the MRS.

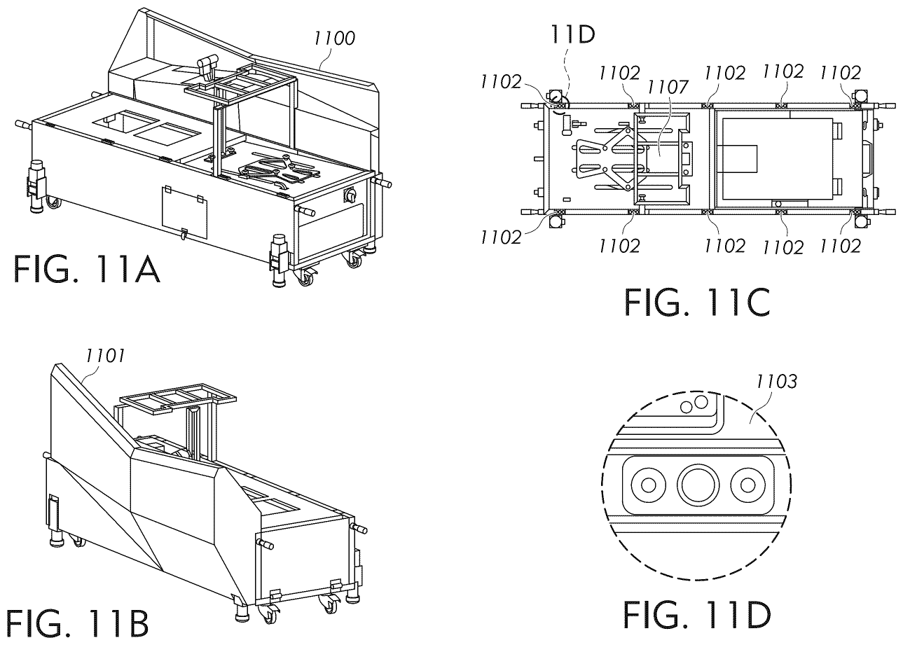

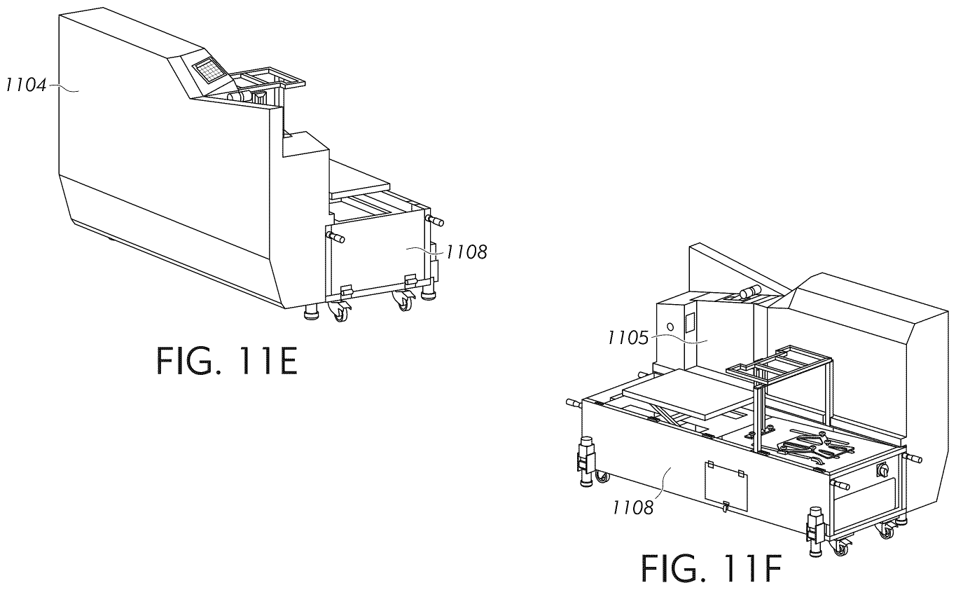

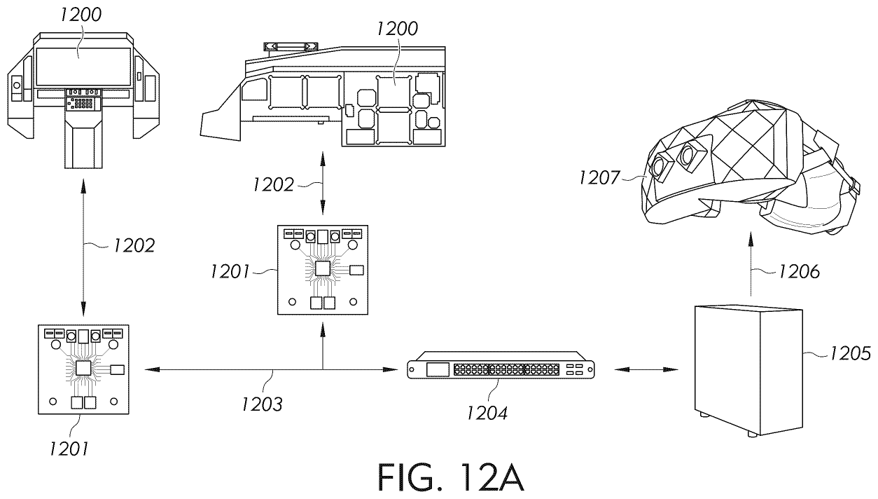

FIGS. 11A-11F illustrate an example of different Instrumental Modules (IM) of aircraft mounted on the Core Module (CM), showing its reconfigurability. As an example, it represents the left IM 1100 of two-engine jet aircraft with embedded throttle connected to Core Module (CM) 1106 from the right side view, where represents the same IM 1101 from left side view Core Module (CM) 1107 has multiple sockets 1102, detailed on, where IM pins 1103 are inserted, physically connecting these Modules. After successful reconfiguration, one or more cables from the IM may need to be connected to the Central Module (CM). These cables can be data cables, power supply cables, or a combination of these two. An example of a different left IM 1104 mounted on Central Module (CM) 1108 from the left side view and represents the same left IM 1104, but IM 1005 is mounted on Central Module (CM) 1108 from the right side view. This example illustrates how simple it is to exchange different Instrumental Modules (IM).

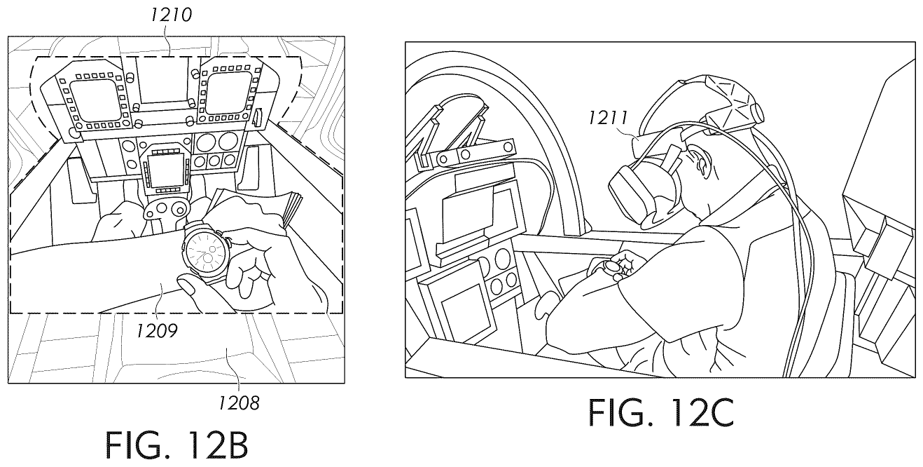

FIGS. 12A-12C illustrate the schematics of the hardware-firmware-software solution, specifically developed to make MRS conveniently reconfigured by the user without needing external technical support. The Instrumental Modules (IM) 1200 may be connected to MRS. They may contain one or more Control Boards (CB) 1201, custom-developed PCB boards with a unique identifier (ID), microprocessor, and ethernet connection. Connection 1202 between physical instruments/controls/controllers and Control Boards (CB) can be any defined communication bus, e.g., Universal Serial Bus (USB), Controlled Area Network (CAN), or other. This connection allows Control Board (CB) 1201 to receive signals from connected Instrumental Modules (IM) and their switches, knobs, buttons, and other controls. Such signals are being translated into a custom communication protocol and transformed into TCP/IP packets. These packets are sent using Local Area Network (LAN) 1203 to Control Switch (CS) 1204, connected to the Computing Unit 1205. The overall time for IM interaction to be detected till the time being received by Computing Unit 1205 is less than 10 ms. Computing Unit 1205 receives these signals and the ID of connected Control Boards (CB) 1201. Computing Unit 1205 runs custom-developed software containing information with the specifications of every control board (CB) ever built and its connected controls. It also includes information on the type of airplane (or any other machine) the Control Board (CB) represents.

Thanks to this information, customized software informs Image Generator (IG) about available connected cockpit controls and which buttons, switches, trims, etc. represent which function in the cockpit. IG renders the final picture and sends it to headset 1207 using metallic, optic, or hybrid (metallic and optic) cables 1206. Mixed Reality picture is created by mixing a virtual environment with a real-time headset mixed reality video stream 1205 Computing Unit knows from 1201 Central Boards which panels of which aircraft (or machine) is connected; therefore, it also knows the shape of that specific cockpit, and it may be able to set the origin (0,0,0) automatically synchronize coordinates of virtual and mixed reality environment and set mapping of mixed reality mask 1210, thus clearly dividing the final picture into mixed reality area 1209 and virtual reality area 1208. The user seated 1211 in an MRS sees the combined picture of mixed reality 1209 and virtual reality 1208, allowing them to interact with the cockpit while immersed in the synthetic training environment.

Because most aircraft cockpits are very different, including a wide variety of special instrumental panels, standard simulators may need to manually or semi-manually program and bind controllers to the Image Generator (IG) running on the Computing Unit (CU). An MRS may be designed to remove this need for any binding process, and thanks to pre-programmed information connecting Control Boards (CB) via their unique Identification (ID), recognizes which controls are connected. It automatically binds on the user's behalf, allowing the user to exchange Instrumental Modules (IM) without needing a specialized technician's deep technical knowledge or assistance.

MRS setup may include the following steps.
The user receives Core Modules (CM) and Instrumental Modules (IM) with the MRS manual and accessories, e.g., cables, monitors, Computing Unit (CU), and headsets.
The user moves the Core Module (CM) to its destination and fixes its position using wheel breaks mechanical or electromechanical legs.
According to the manual, the user mounts Instrumental Modules (IM) to appropriate positions.
After physical installation, the user connects the IM cables to the Core Module (CM) and connects other accessories according to the manual.
The user connects the Core Module (CM) to the electrical grid.
The Computing Unit (CU) boots the system, or the user installs a customized software package to obtain the MRS applications.
Custom software automatically detects virtual and mixed reality headsets, and an image generator is installed on the computing unit (CU), tracking system, and instrumental modules.
Custom software automatically maps/connects specific controls to Image Generator (IG) software.
Connected Instrumental Modules are also visualized in custom software, showing their physical shape. They are used for mixed reality masking and connected instrumental panels with controls and statuses.

Some embodiments may decrease the time needed for reconfiguration and technical expertise of personnel reconfiguring MRS, resulting in a fraction of the cost compared to a standard simulator.

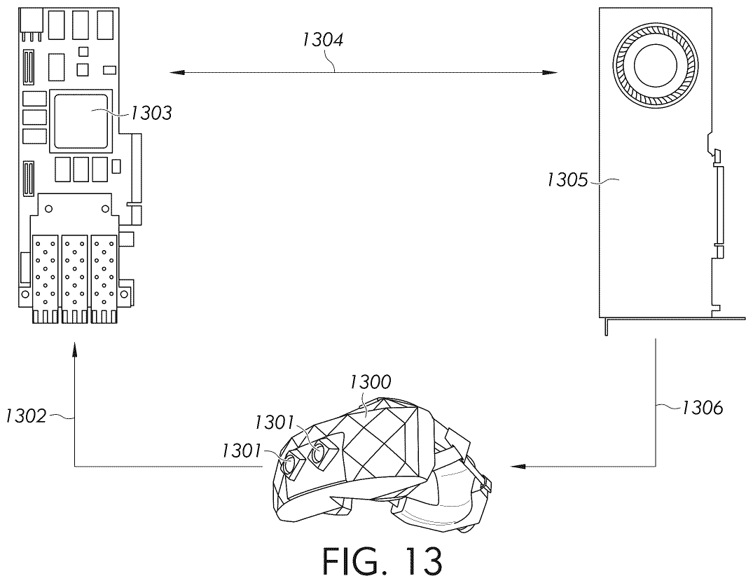

FIG. 13 illustrates an MSA, which includes Mixed Reality headset 1300, connected via optical or hybrid (optics with metallic) cables 1302 to FPGA 1303 (or another electronic device(s)), which may be connected using computer high-speed bus 1304, e.g., Peripheral Component Interconnect Express (PCI Express) to Graphical Processing Card (GPC) 1305, generating the final image, which is being sent back to Mixed reality headset 1300 using metallic, optical or hybrid (optics with metallic) cables 1306, or any other suitable means to send electronic signals. Mixed Reality headset 1300 incorporates stereo camera module 1301, which captures two real-time video streams. The key difference between this unique hardware architecture and currently existing systems is that no processing occurs within the Mixed Reality headset. Additionally, thanks to the usage of the FPGA 1303 card, processing may take guaranteed, e.g., 1 ms, thus limiting overall system latency. Latency may be further decreased by the capability of GPU 1305 direct access memory of FPGA 1303, without a need for delays caused by the Central Processing Unit (CPU), which takes place in currently existing systems. Due to these multiple innovations, MSA some embodiments may decrease the data flow latency by multiple milliseconds.

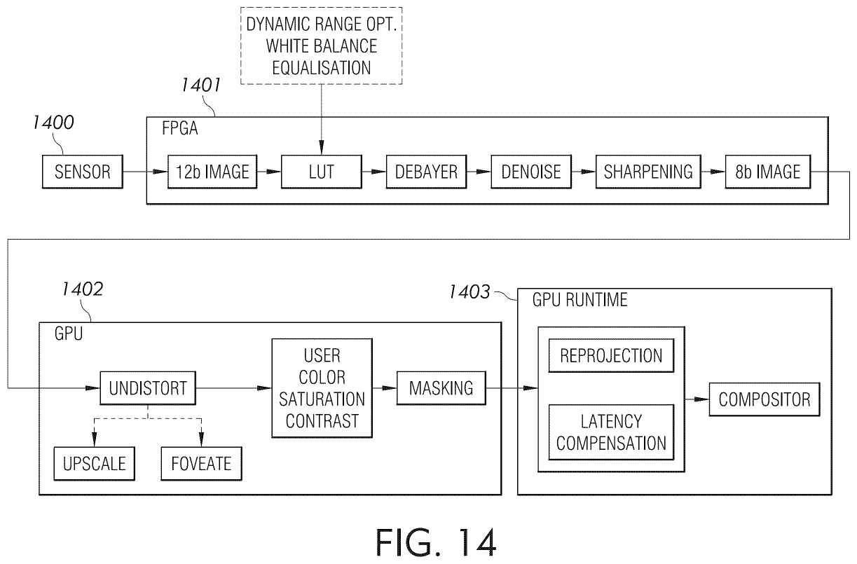

FIG. 14 illustrates the data flow and unique algorithm set to deliver the highest mixed reality performance with minimal latency. Video streams captured using sensors 1400 (digital camera chips) are being transferred as raw data into the FPGA 1401 card. Such video images are processed using Lookup Table (LUT), a standard part of every image processing pipeline. In addition, the color dynamic range is being optimized with white balance and equalization to enhance the input signal. This process is followed by a custom Debayer method, which recovers full pixel colors from a Color Filtering Array image (CFA). The central part in increasing the overall mixed reality picture fidelity and user readability leans into the custom Denoise and Sharpening algorithm combo. These algorithms can be based on advanced filtering methods and Artificial Intelligence (AI) neural network principles, and their order can be exchanged according to their specific type. At the end of the FPGA processing pipeline, the image color depth is lowered from 12 bits to 10 bits or 8 bits for the following processing. Such FPGA-processed data are transferred to GPU 1402, where a distortion algorithm takes place to compensate for the optical system of specific lenses used with cameras.

As a part of undistortion, upscaling of the whole picture or foveated part can further increase picture quality. To enhance color depth, another algorithm takes place to balance color saturation contrast, followed by masking. Masking cuts out unrequired parts of the video image. Unrequired parts of the video can be set by the user defining in 3D space which parts of the real world should be projected into mixed reality, overlaying the virtual reality, or masked based on a standard color selection, also known as “green-screen” masking. There are various techniques to mask the picture; these two examples were given only to envision what the process of masking does to the video image itself. As a last processing step, the GPU 1403 runtime algorithm reprojects the mixed reality picture, aligning it with virtual reality and adding latency compensation. These steps, executed in the GPU 1403 runtime algorithm, may play a role in perceiving the current and realistic feeling when combining video images with virtual reality, creating a mixed reality. This is described in the following paragraphs as another example embodiment. After that, the processed image is sent to the Compositor, which combines the IG-generated data on the computer and sends it back to the Mixed Reality headset.

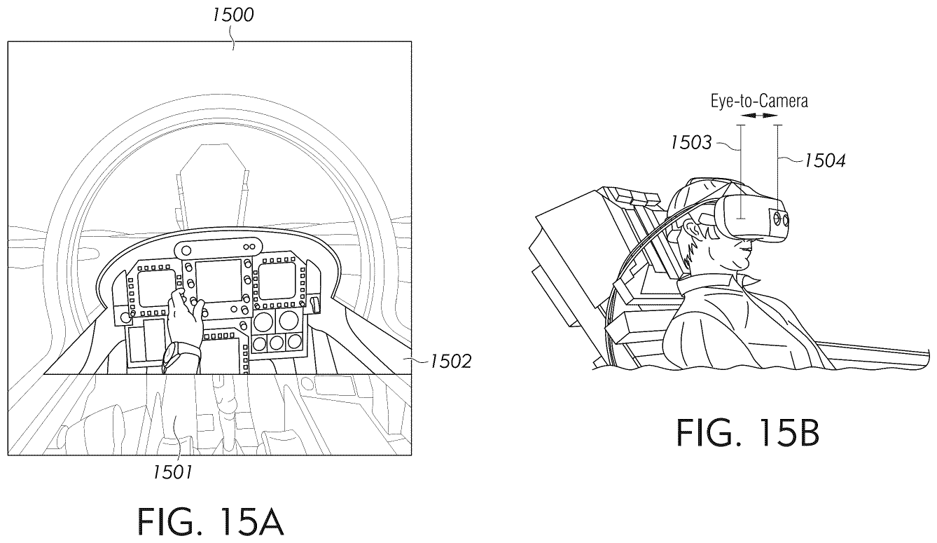

FIGS. 15A-15B illustrate the first-person mixed reality view using an MRS. This image includes the following parts: virtual reality simulated environment 1500 (outside of the cockpit), Virtual 3D cockpit 1501 of an airplane and immersed view 1502, real-time video stream from Mixed Reality headset cameras, which is cut according to the cockpit dimensions, which is being overlayed over the Virtual 3D cockpit 1501. These layers are being rendered over each other, creating a final unified simulated image.

Cameras 1504, used for mixed reality video or see-through, are positioned a few centimeters in front of the 1503 virtual reality headset user's eyes. This causes inaccuracies in users' perception and mispositioning of real objects like the cockpit against objects in virtual scenes. This cannot be compensated by any naive scaling method or without knowledge of 3D space in the scene. Inaccuracies are observable, especially for nearby objects. The following text describes a solution to this problem.

Every Mixed Reality trainer experiences this challenge of picture misalignments between virtual scenes and real-time video from front-facing cameras. This phenomenon, which disrupts immersion, can be described as a “floating” or “drifting” visual artifact and is noticeable during faster head rotations. To compensate for this phenomenon, we developed a unique algorithm that can use data from multiple sources to estimate image correction and properly align the virtual environment with real-time camera video streams.

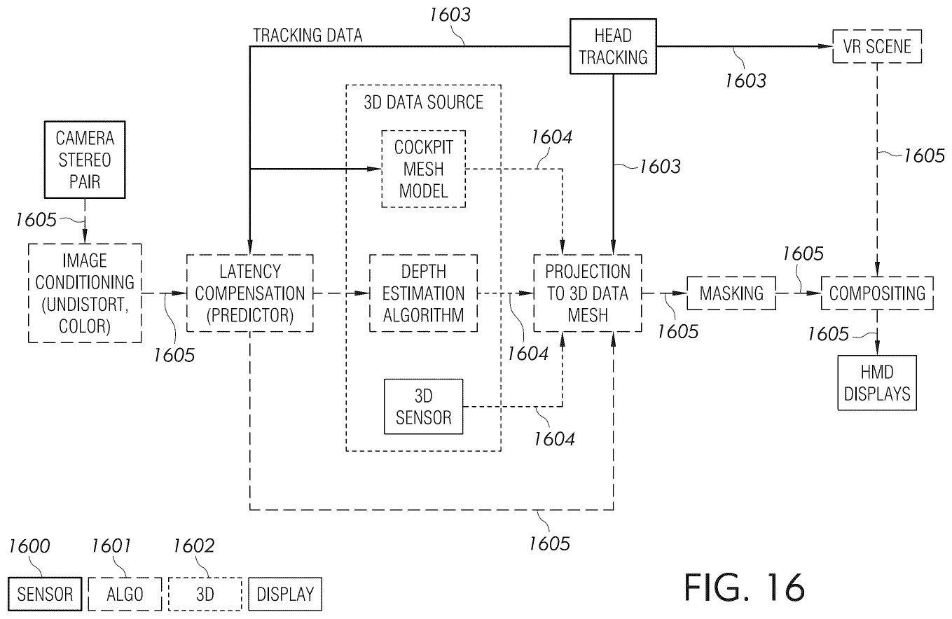

FIG. 16 describes a compensation method for correct virtual and mixed reality alignment. Orange blocks 1600 stands for data sources from sensors Blue block 1601 represents developed algorithms, and green block 1602 represents sources of 3D data. Orange arrows 1603 represent the flow of tracking data, green arrows 1604 represent the flow of 3D data, and blue arrows 1605 represent image data streams.

When data are captured on stereo cameras, the image is undistorted and processed to enhance color and clarity. Image data are then rotationally reprojected to compensate for transfer and capture latency. After these initial operations are performed, the real-time depth perception of this data source can be obtained from the picture from the same mixed reality cameras of a separate sensor. The real-time depth map is combined with a 3D cockpit model of a specific MRS. At this point in processing, the pipeline correction algorithm can be applied, bending the video real-time stream accordingly to the 3D shape of the cockpit. This process, however, needs to be precisely synchronized with Virtual Reality image rendering to be visualized with the correct rendered frame. Due to the lower latency of the virtual reality rendering image pipeline, an additional estimation algorithm must be used to estimate the latency difference between virtual and mixed reality scenes. As a part of the projection to 3D data mesh algorithm, 2D image data are being reprojected to 3D space using data mesh while shifting its position against a virtual, mixed reality camera, moving it to the real position of the user's eyes (Virtual Reality cameras). In addition to data sources, this algorithm also needs head-tracking data for correct functioning. After rendering viewports using virtual cameras placed in the user's eye position, the masking and VR scene composition take place together with the image-warping algorithm.

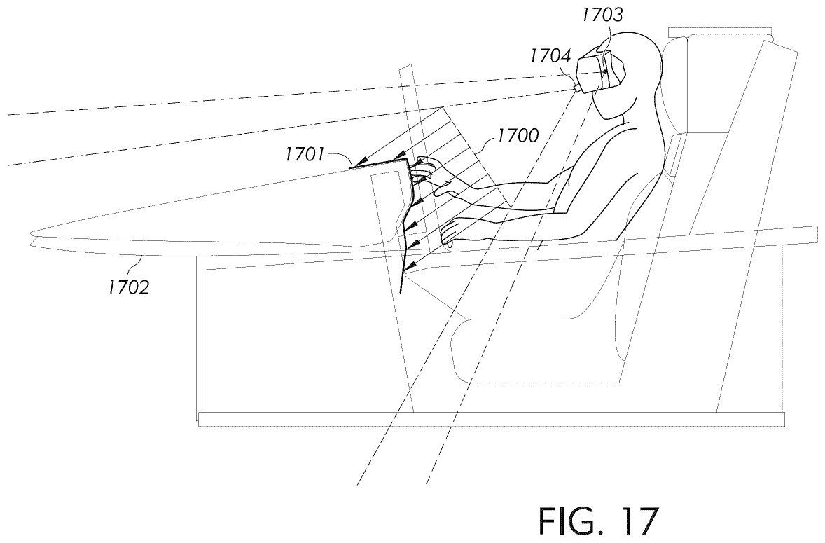

FIG. 17 illustrates an example of a Modular Reconfigurable Simulator setup with a mixed-reality headset using a virtual and mixed-reality alignment method. A flat stereo image 1700 may be captured by Mixed Reality cameras 1704, positioned in front of a Mixed Reality headset. As shown in FIG. 17, the position of users' pupil 1703 does not match the position of Mixed Reality camera 1704, allowing a user to visualize the known 3D mesh object 1702, which is one of the data sources entering this algorithm. 1701 visualize the final reprojected 2D stereoscopical image on the 3D mesh object.

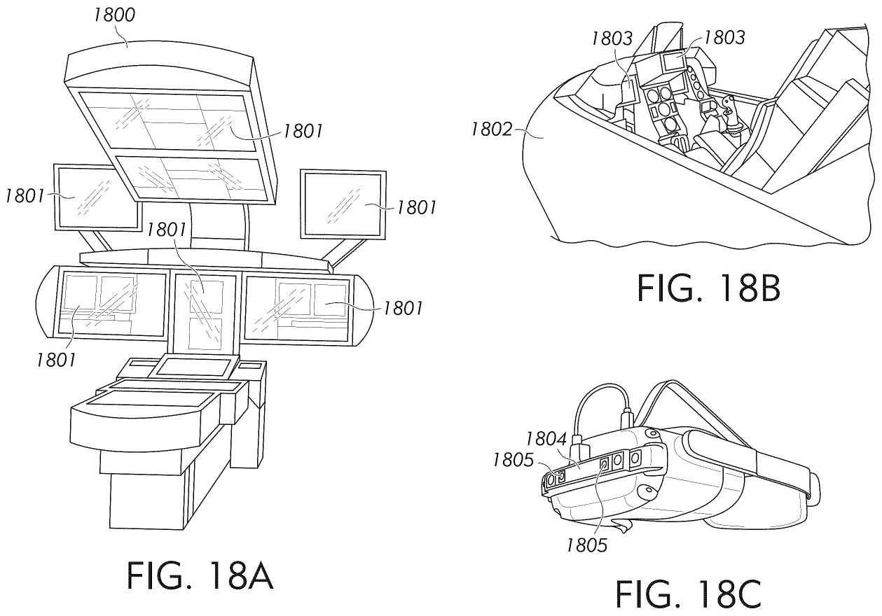

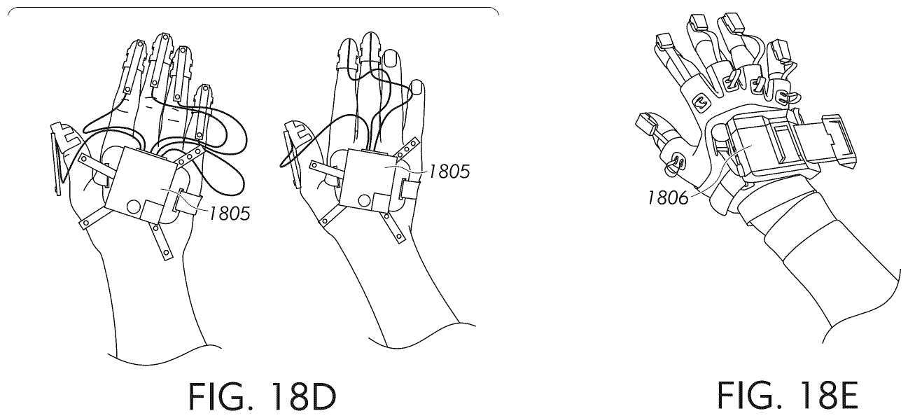

FIGS. 18A-18E illustrate the most common ways to interact with simulators using currently available technologies. They vary from the most basic ones to the most realistic. One of the standard interfaces used by lower fidelity simulators 1800 is being realized using touch areas 1801. These touch areas can be based on capacitive or resistance layers/foils, often combined with display panels, which visualize panels. This means that the end-user/pilot using the simulator sees the visualized instruments on a 2D screen, and when touched, a video/animation response appears, changing instrument status or position. It is one of the most common approaches in the beginning stages of pilot training, primarily focused on cockpit familiarization. 1802 The more sophisticated simulators use actual instrumental panels 1803 or replicas, including switches, trims, buttons, and controls, as in real aircraft. These simulators are much more advanced and expensive because the controls need to be connected to the computer and programmed according to the real action in the simulated airplane. Controls can be passive or active (control loaded), simulating realistic physical force/resistance.

With the progress of Virtual and Mixed reality usage, we discovered and verified with potential customers that there is a need and high added value in cockpit precise hand-tracking capability, which will allow trainees to interact virtually with any cockpit controls and instrumental panels or provide precise hand position information in real-time while using virtual or mixed-reality.

The problem with existing hand-tracking technologies is the precision of the finger tracking and coverage of the tracked area. Currently, existing technologies do not perform in a cockpit environment. Camera-based systems 1804, mounted on virtual or reality headsets, recognize fingers and create an adequate 3D model. Their sensor's 1805 accuracy may be limited by its vision capability, and precision declines with the distance from the sensor as well as with increasing view angle. Infrared 1805 and other glove-like absolute systems 1806 needed trackers to be precisely positioned on fingers and fingertips, causing inconvenience in the continuous recalibration process.

In an example embodiment, the Virtual Reality Cockpit Handtracking (VCH) system may employ optical sensors combined with convolutional neural networks (CNNs) trained on datasets of hand and finger movements under various lighting conditions. The ML algorithms may detect and predict hand positions with sub-millimeter accuracy, enabling naturalistic interactions within the VR environment. Similarly, the Mixed Reality Cockpit Handtracking (MCH) system may integrate depth-sensing cameras and AI-based calibration models to overlay real-time hand positions within mixed reality spaces. Calibration may involve iterative adjustments to align virtual hand models with physical hand movements, ensuring a seamless user experience.

Hand-tracking for virtual reality in the cockpit is so challenging, and no technology has solved it fully until now because the precision over the whole cockpit environment needs to be higher than the close distance between two controls. The cockpit (especially jetfighter) is a very complex environment with many visual elements and reflexive areas, which interfere with the known hand-tracking sensors and algorithms. Tracking needs to have full coverage of the cockpit from an appropriate angle, ideally, 90 degrees, to define where the fingers of the user are. For example, setup cannot be achieved with one sensor.

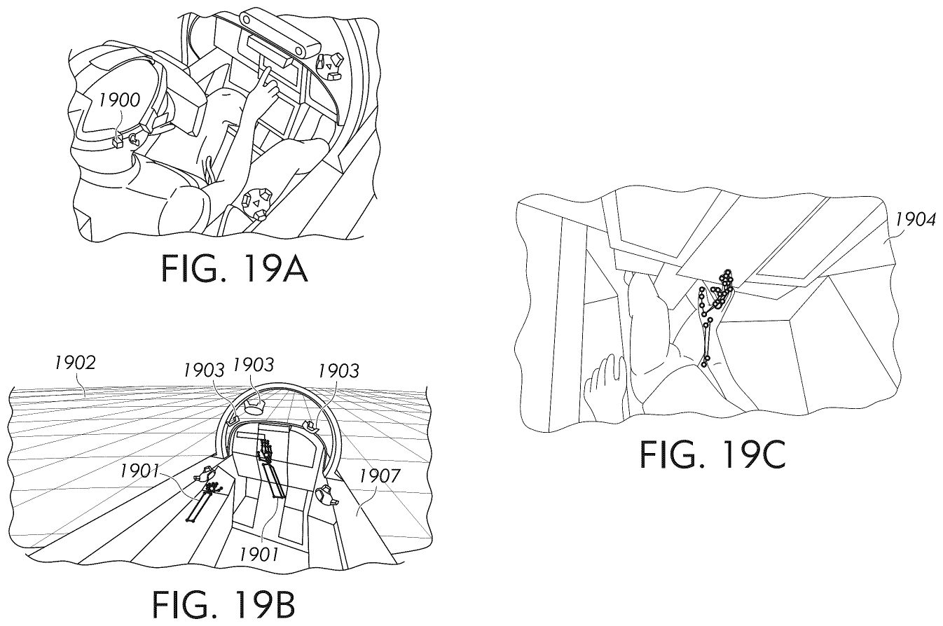

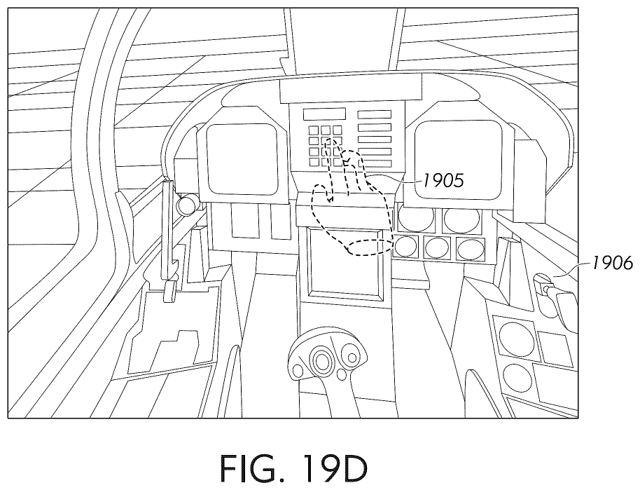

FIGS. 19A-19D illustrate an example of Virtual reality Cockpit Hand-tracking (VCH), represented by a functionally interconnected array of precisely calibrated hand-tracking sensors combined with a data merging algorithm used in an MRS cockpit. FIG. 19A provides a third-person view 1900 of the user, seated in MRS, using his right hand to interact with the virtual cockpit. For correct functionality of Virtual reality Cockpit Handtracking (VCH), multiple optical hand-tracking sensors 1903 may be interconnected and precisely synchronized in time. Their data quality is evaluated by an AI-based algorithm, which values/marks them according to their visibility angle.

In some embodiments, the Virtual Reality Cockpit Handtracking (VCH) system utilizes machine learning algorithms to enhance the precision of hand and finger tracking within complex cockpit environments. This system may include optical sensors arranged to provide complete tracking coverage, capturing hand movements as users interact with both virtual and physical controls. Machine learning algorithms trained on aviation-specific gestures interpret these movements in real time, dynamically adjusting detection sensitivity based on proximity to specific cockpit controls, such as toggles, levers, or switches. This intelligent adjustment may help ensure that tracking accuracy remains consistent, allowing users to interact with virtual cockpit elements with precision comparable to interacting with physical controls. This enhancement may provide for training scenarios requiring intricate hand-eye coordination and high fidelity in user interactions.

Thanks to this approach, data from a better-positioned sensor in every situation has a higher impact on the final hand and finger-tracked position over the other sensors. In an example embodiment, tracking sensors 1903 may need full coverage of the virtual cockpit 1906. A virtual reality scene in 1902 may be a calculated 3D space, which combines information about 1903 handtracking sensors' position and detected hands and fingers' position in 1901 and aligns it with the 3D cockpit model 1907 of a specific MRS. The virtual reality Cockpit Handtracking (VCH) system uses a proprietary algorithm to align sensors 1903 within the same coordinates of the MRS cockpit while using available off-the-self handtracking sensors such as Leap Motion (also known as Ultraleap). The proprietary algorithm takes raw detection data 1904 from the sensors, marks the detection quality, and merges signals from sensors detecting the user hand together, resulting in a virtual reality hand model 1905 visible in a virtual reality scene/environment 1906. To execute this task, the algorithm needs to know the exact position of the handtracking sensors. This information can be obtained in three ways.

By precise positioning sensors and mounting them on well-known and documented places in Instrumental Modules (IM). If this approach is not possible or time or cost-inefficient, their precise position can be tracked by an additional tracking system by connecting handtracking sensors with positional trackers and deducting their offset. The third approach, developed as a part of the systems, methods, and devices described herein, is called Constellation Calibration (CC). Constellation Calibration (CC) is an algorithm that automatically detects the position of one handtracking sensor within the proximity of the other handtracking sensor. This self-measurement process can define the relative position of the sensors, which have visibility of at least one other handtracking sensor. After successfully executing this measurement, the initial sensor becomes an origin of the constellation coordinate system and needs to be aligned with the virtual cockpit position. Such a calibrated hand-tracking system with a sensor fusion algorithm can combine the data from multiple sensors and assign precise sensor visibility values for every captured frame, thus providing complete cockpit hand and finger tracking coverage.

The added value of this solution is that when equipped/upgraded with this technology, any existing Virtual Reality simulator will provide the user with a human-machine interface to interact with any available controls in the virtual reality environment. This brings massive cost-savings to any simulator, which lacks specific parts of controls and does not need them to be purchased, installed and integrated physically. In addition to virtual cockpits and thanks to multiple types of sensor alignment processes, virtual reality cockpit handtracking (VCH) can be equipped with fully functional cockpit replicas, which allows the measurement of biofeedback data. In a similar way, eye tracking is used to analyze where the user is looking during training scenarios. Hand and finger movements can be captured, post-processed, and analyzed in a similar way by instructors, supporting the learning process while showing pilots where they clicked the wrong button in time or if their response time was too slow/fast due to previous position of hand and fingers before the specific situation happen.

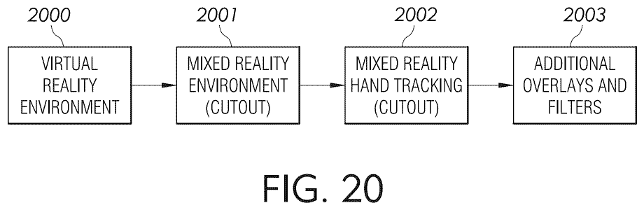

FIG. 20 illustrates the Mixed reality Cockpit Handtracking (MCH) system. MCH is an algorithm composed of four main specific rendering pipelines connected in one chain. A First Pipeline 2000 renders a standardized virtual reality environment, which virtual reality headsets can directly use. This virtual reality picture enters the mixed reality 2001 rendering pipeline, which processes real-time video streams from mixed reality cameras mounted on the headsets. This video is in real-time cutout according to user settings, such as the shape of a cockpit or any other cutout and forms Mixed Reality Environment 2001, overlapping virtual reality and entering the 2002 rendering pipeline. This pipeline consumes the same real-time video as the mixed reality 2001 pipeline. However, in real-time, it detects and cuts out only detected hands, using AI algorithm trained on big data of hand pictures in a cockpit and other environments. The extracted video steam of cutout hands is again overlayed with the 2001 output signal. Such a signal can already be used for mixed reality headsets to visualize the mixed reality environment with hand overlay. In some specific cases, additional video layers 2003 might be added to the signal. Additional overlays and filters can be imagined as an infrared filter applied to the final scene, changing its overall look into a different spectrum, night vision filters, detection of other crew members, or simulated augmented reality glasses information layer commonly used in advanced jetfighters and helicopters.

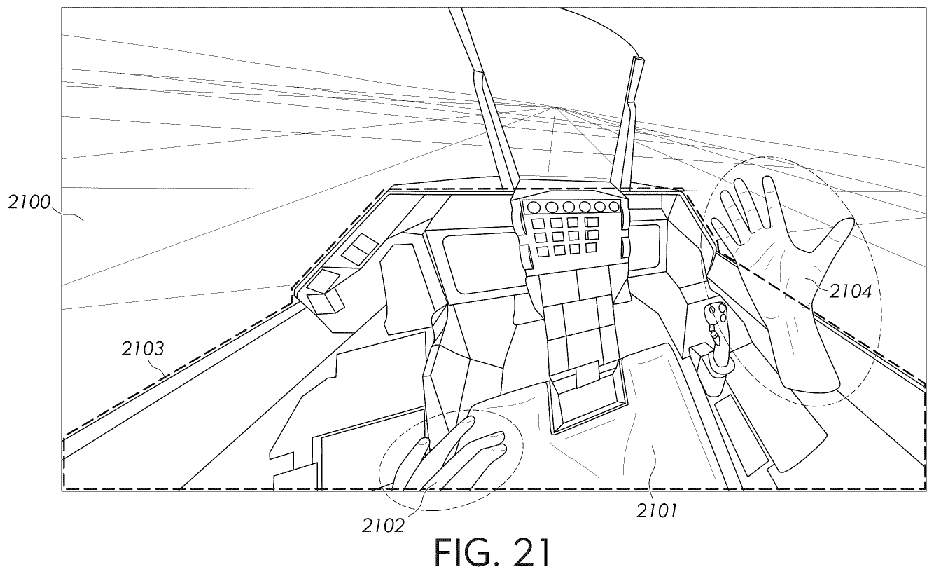

FIG. 21 illustrates a first-person view of a MRS using Mixed reality Cockpit Handtracking (MCH). A virtual reality environment 2100 may be generated in the computing unit (CU) by an image generator (IG). MRS cockpit 2101 can be rendered virtually using IG or a real-time video overlayed with virtual reality using Mixed reality cameras in Mixed reality headsets. Line 2103 symbolizes the preset cockpit cutout shape in a given time for this specific frame. The cutout hands 2102, 2104 may be overlayed on the mixed reality signal. While hand 2102 may be visible in a standard mixed reality headset because it is inside the 2103 area, the upper part of hand 2104 may be missing, and the user will see the rest of the concrete runway instead. The hand cutout represents the last video layer overlayed over the virtual and mixed-reality picture. This figure visually describes the advantage of the Mixed Reality Cockpit Handtracking (MCH) system in showing a specific scenario where the hand of the user will disappear instead of being visible as it is supposed to be in a realistic simulation.

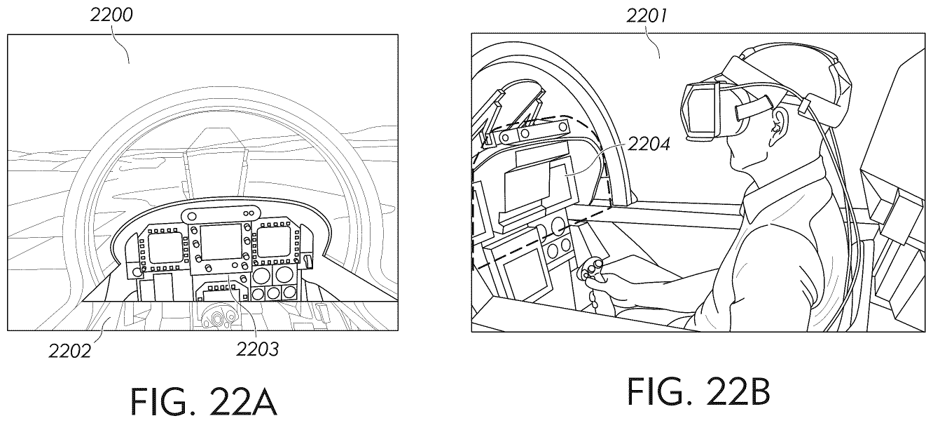

FIGS. 22A-22B illustrate a challenge of mixed reality immersion caused by differences in the ambient lighting of virtual reality and any real cockpit Virtual reality environment 2200 changes ambient cockpit lighting according to the Image Generator (IG) capabilities, which are at a certain level realistic and correspond with the rest of the synthetic training environment. The real environment 2201, where MRS or any other simulator is physically installed, shows completely independent ambient light, depending on its environment factors. This causes a visible difference in otherwise aligned Virtual Reality scene 2202 and mixed reality cutout 2203, visualizing the first person's view of the 2204 area in the real environment, disrupting the immersion.

This lightning misalignment is especially visible when the user changes its simulated aircraft direction from flying against the sun to flying from the sun. The misalignment also negatively influences the realism of users' capability to read different warnings and alerts in the cockpit.

Previously, there has been no realistic lightning emulation of cockpit instrumental panels. The fact is that standard data-projector-based or screen-based simulators reflected the light coming from the light source, and exact lightning emulation was, therefore, impossible.

Using Mixed Reality technology, exact lightning simulation is possible to emulate because the visualization system (screens of Mixed Reality Headset) does not influence cockpit lightning

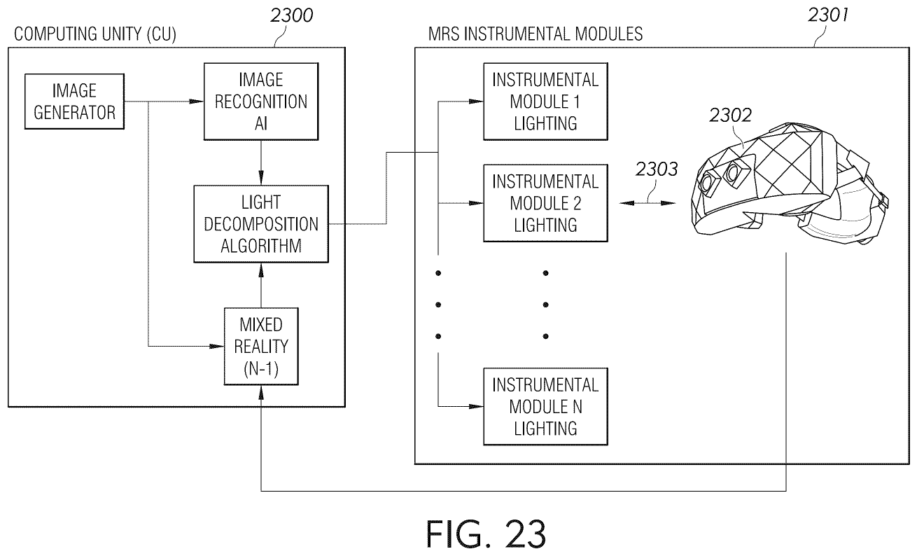

FIG. 23 illustrates the Realistic Cockpit Lightning (RCL) system, including a hardware-software solution emulating simulated lightning in the MRS cockpit. When the Image Generator (IG) generates a virtual reality environment on Computing Unit (CU) 2300, the image is analyzed by an AI recognition algorithm, defining which parts of the cockpit are being seen by the user. Cockpit parts are divided into blocks corresponding with Instrumental Modules (IM) 2301. These blocks are afterward separately sent to the Light Decomposition Algorithm, which defines the intensity and color of light on each block, translating this information into an intensity of separately controlled LEDs installed in Instrumental Modules (IM), controlled by Control Boards (CB). These LEDs create ambient lightning 2303 of the MRS cockpit, which may be visible in mixed reality online video of mixed reality headset 2302. Each frame of this video stream is used in a feedback loop, correlating the end lightning result with the generated initially virtual reality environment of the cockpit, immediately autocorrecting Light Decomposition Algorithm intensity and color variables in case of a mistake or changing real environment lighting such as sun movement, turning on/off lights in the building where MRS is installed or others.

This innovative approach is independent of the Image Generator (IG) and can be used with any existing cockpit simulator if upgraded with Realistic Cockpit Lightning (RCL).

Automatic Tracking Setup: the ATS system resolves the inconvenience of positional calibration, which is needed before every simulation session. The tracking system coordinate space is not connected to the Image Generator (IG) coordinates. This means that tracking has its own [0,0,0] origin, which is unknown to the [0,0,0] origin of the Image Generator (IG) and does not have any link to the real position of the physical cockpit in the real space. The normal procedure used by existing systems is that the user seated in the standard simulator is asked to sit and look straight while the simulator operator or user clicks a calibration button, synchronizing coordinate systems origins. This approach has a significant flaw: calibrating the origin into the average user position (height) in the virtual cockpit, causing misalignment, which may need to be afterward manually corrected in the Image Generator (IG) by moving the virtual camera in a synthetic training environment lower or higher. If this correction does not occur, the end-user/pilot will have an incorrect eye point, causing negative training and an inaccurate view outside the cockpit.

Automatic Tracking Setup ATS is a software-hardware system that uses an absolute outside-in tracking system mounted on the position in an MRS or an additional inside-out tracking module embedded in VR/MR headset with multiple unique visual codes, e.g., ArUco, QR, or other, placed on exact known positions in MRS.

When using an outside-in absolute sensor, the Automatic Tracking Setup (ATS) custom algorithm includes knowledge of Instrumental Module (IM) configurations and tracking positions. This enables the algorithm to determine the tracking's position in relation to the physical MRS and the headset calibration pad, thereby connecting the virtual origin of the Image Generator (IG) to the origin of the outside-in tracking system, as well as aligning it with the shape and position of the MRS cockpit. Due to its inherent design, this setup is deployable to any motion platform without requiring adjustments or motion platform compensations.

When using an inside-out tracking relative sensor, the MRS may have multiple unique visual identifiers represented by ArUco, QR codes, or another graphical pattern. These are positioned in exact locations on the cockpit. Information about their precise position is connected to a 3D model of the MRS cockpit, which is connected to Instrumental Modules (IM) and stored in Automatic Tracking Setup ATS custom software. The VR/MR headset recognizes the pattern from embedded mixed reality or inside-out tracking cameras. Automatic Tracking Setup ATS custom software triangulates the position of itself against the cockpit, thus aligning the coordinate origins of virtual and real environments.

During the usage of inside-out tracking, gradually, as the user moves, a phenomenon called “drift” occurs, causing a shift in the displayed image compared to reality. This causes misalignment of virtual button visualization and their real-world position, preventing the user from interacting with MRS Instrumental Modules (IM), leaving him unable to press the correct buttons accurately and typically operate the cockpit. Inside-out tracking tracks its position from two calibrated cameras, detecting so-called feature points in space, which are being compared between captured images, recalculating relative spatial orientation. However, they do not provide absolute size and position, and as the user moves with the headset, the image gradually shifts relative to reality. This shift may be caused by various factors such as temperature, recalculations, and other factors. Inside-out tracking only ensures relative tracking. It autonomously identifies feature points in the 3D space of the cockpit and orients itself based on them without obtaining any fixed, standardized, and defined anchor points.

To ensure spatial accuracy and reduce calibration time, some embodiments include an Automatic Tracking Setup (ATS) that may continuously aligns virtual and physical coordinate systems within the simulator. The ATS may incorporate outside-in or inside-out tracking configurations and utilizes predefined calibration markers, such as QR codes or ArUco markers, precisely placed on various cockpit elements. During use, the ATS software may perform real-time triangulation and spatial mapping, synchronizing the headset's position with the cockpit's physical layout. This alignment may be maintained even as the user moves within the cockpit, correcting any drift associated with inside-out tracking systems. By preserving spatial accuracy without manual recalibration, the ATS may provide a seamless transition between virtual and physical interactions, ensuring users experience consistent and precise alignment of VR/MR environments.

To overcome this phenomenon, a new space calibration system was invented, where inside-out tracking with feature points is combined with ongoing calibration, which can measure the length and depth of the space due to the knowledge of precise positioning and size of codes from initial origin calibration.

The Automatic Tracking Setup (ATS) works as follows:
A calibration pattern with defined dimensions, design, and shape is created and precisely installed on Instrumental Modules (IM) or shown on IM displays.
The ATS custom software saves information about pattern specification, position, and ID of Instrumental Modules (IM)
The user starts Image Generator (IG) and puts on a VR/MR headset with embedded inside-out tracking.
The calibration pattern is captured by an inside-out stereo camera placed on the headset, calibrating the headset in terms of dimensions, scale, overall size, and shape and defining the headset's position in space, establishing a fundamental zero point of the coordinate systems.
Inside-out tracking is initiated, and the system orients itself in space, generating a static map of feature points in the 3D space of the MRS cockpit.
The calibrated headset in the 3D cockpit space is now being tracked by embedded inside-out tracking, and the user can freely use an Image Generator (IG)
The headset's position may be continuously or continually corrected during usage. As soon as head movement, and consequently headset movement, inside-out tracking starts to exhibit drift, meaning a shift in the displayed distance in space compared to reality, resulting in misalignment.
Continuous correction is done by aligning the headset with the fundamental zero point. When the headset reaches the same position in space as the fundamental zero point during movement, and the headset's direction matches that during the calibration image capture, the static map of feature points is compared with the image, and the drift is automatically corrected, thanks to the calibration pattern serving as a marker of initial position.

In some embodiments, the Drone Remote Training (DRT) module may integrate gyroscope-controlled cameras and multi-axis motion sensors for real-time flight simulation. The MRS system synchronizes drone telemetry data with the training module, enabling accurate simulation of drone dynamics, including wind resistance, altitude control, and obstacle navigation. Trainees may receive real-time feedback through haptic controls and visual overlays generated by the VR/MR headsets, enhancing situational awareness and operator skill development.

Some embodiments may simplify the usage of virtual and mixed reality usage within cockpits, removing the positional calibration process, thus saving time and increasing the convenience of the technology itself. The Automatic Tracking Setup (ATS) can be executed using different sensors, including outside-in or inside-out tracking.

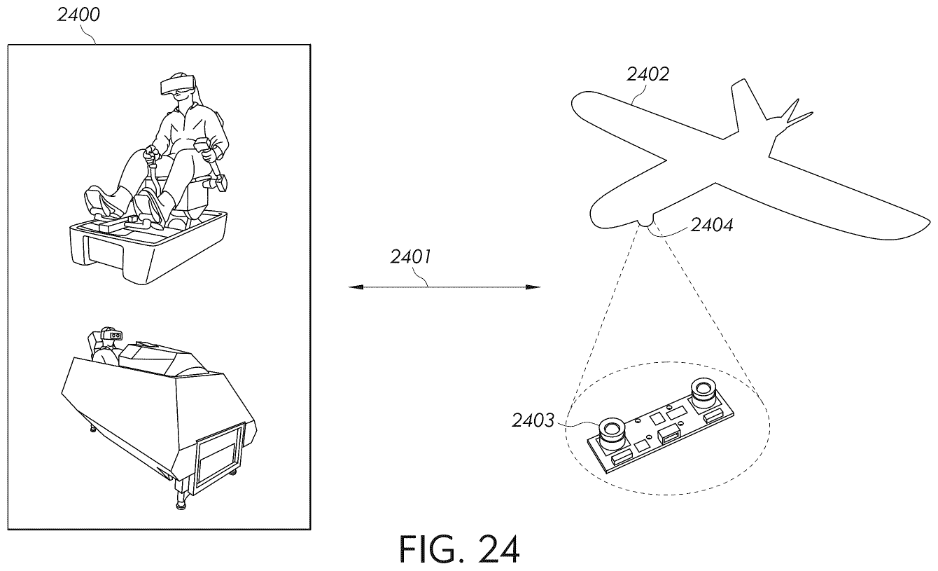

FIG. 24 illustrates the innovative system of extended pilot training and drone operation called Drone Remote Training (DRT). This system includes MRS 2400 or any other simulator, connected to low latency wireless broadband internet connection 2401, e.g., Skylink or any other low latency wireless broadband internet connection, connected to drone 2402 equipped with mixed reality module 2403.

To understand this innovation, it may be necessary to understand the pilot training syllabus. Pilot training typically begins with a foundational stage of cockpit familiarization, which involves using printed instructional materials or documentation. Following this initial phase, trainees advance to computer-based simulations designed further to develop their knowledge and proficiency with the aircraft. These two steps are followed by learning how to fly with real propeller high-wing airplanes, followed by subsonic and supersonic airplanes until the final aircraft platform is reached.

This system stands in this process between the last simulation training and actual flight. It is an additional step within the future pilot training syllabus, combining cockpit replicas of mixed-reality simulators connected with remote-controlled drones. It allows users to train standard and emergency procedures using less expensive drone flight hours rather than actual aircraft. Thanks to our MRS 2400 and mixed reality pass-trough camera module 2403, mounted on an airplane-like drone on a remotely controlled gyroscope head, DRT provides users seated in MRS with a first-person view, like seated in the cockpit of a small airplane. Drone 2402 may need to have integrated wireless, preferably worldwide satellite broadband, low-latency internet, allowing real-time connection via a secured channel to MRS, which needs to be reachable within the same network.

While the user is seated in a training facility anywhere in the world, using a VR/MR headset, they can see the hands in the simulated cockpit interior of MRS with connected Instrumental Modules (IM) while experiencing real-time video stream from mixed reality cameras mounted on aircraft-like drone everywhere outside the cockpit. Virtual or Mixed Reality headset is connected to the tracking system, which provides rotational data, which are being sent in real-time to the drone, directly controlling the rotation of gyroscope head 2404 where the mixed reality module is mounted. Whenever the user rotates their head, the mixed reality module on the drone follows the same direction.

Thanks to MRS procedural training capabilities, users can train the exact processes and procedures as seated in the real cockpit to start aircraft and any other operation. When the image Generated (IG) simulated model is ready, the drone connects to the throttle and stick Real-time drone control and navigation unit data are visualized on MRS-connected Instrumental Modules (IM). The user consumes the same amount of visual information as seated in an airplane (only lower over the ground) with the availability of information from simulated Instrumental Modules (IM) to execute training scenarios.

A factor of this training is that the user pilots a real aircraft under real-life circumstances, such as weather, air, heat, etc. Another factor of this training is the stress connected with actual responsibility for the drone, which can crash if mismanaged, increasing the realism of the training scenario.

One benefit of this training approach, aside from much cheaper flight hours of actual airplane, is the potential to connect any MRS configuration emulating any existing airplane type. This system can simulate turboprops, jetfighters, airliners, or helicopters. The only difference may be in the speed and maneuverability of the aircraft, which can be modified digitally. The onboard systems may be the same and accurate as in the real aircraft, thanks to MRS capabilities.

The same setup can be used in addition to operating any drone from a first-person view. Current drone operators use standard 2D LCD monitors with stick and throttle connected to the control computer for piloting. The Drone Remote Training (DRT) system brings its controlling closer to flying an actual airplane rather than a remote drone operation. This allows standard pilots to immediately start controlling drones because of their flight skills and DRT situation awareness visual information matching the actual aircraft flight.

In an example embodiment, the MRS system may be a flexible and highly adaptable flight training solution comprising a Core Module (CM) with a user seat and multiple interchangeable Instrumental Modules (IM). These IMs may be designed to emulate cockpit control interfaces for diverse aircraft types, including fixed-wing, rotary-wing, and drones. The MRS may incorporate a user-friendly mechanism for seamlessly exchanging the IMs, enabling quick configuration changes between aircraft types. Additionally, the system may integrate support for Virtual and Mixed Reality (VR/MR) headsets to create immersive environments. It is equipped with a Computing Unit (CU) containing software that recognizes and configures each IM based on its unique identification system. This CU may allow the MRS to adapt the virtual model of an aircraft cockpit in real-time, providing users with specific aircraft controls for training scenarios.

In an example embodiment, the MSA may be another aspect of the system, designed to optimize mixed reality experiences through a dedicated hardware and software configuration. This architecture may include an FPGA and GPU that render high-fidelity virtual environments in real time, processing video streams from a stereo camera module on a VR headset. Algorithms within the MSA may enhance the video quality by optimizing color dynamic range, debayering, denoising, and sharpening, while a latency compensation mechanism may further improve the user experience by utilizing the FPGA's direct memory access to minimize processing delays.

In an example embodiment, the Virtual Reality Cockpit Handtracking (VCH) system may provide precise interaction capabilities in a virtual cockpit environment. This system may include an array of optical sensors for detecting hand and finger movements and a processing unit that generates a real-time 3D model of the user's hands. A software application may interpret these 3D models to simulate interactions with virtual cockpit controls, while a machine learning algorithm enhances tracking accuracy based on user interactions, delivering a seamless and responsive handtracking experience for users.

In an example embodiment, the Mixed Reality Cockpit Handtracking (MCH) system may build upon VCH capabilities, extending them to mixed reality environments within simulator cockpits. The MCH system may include multiple handtracking sensors that provide comprehensive tracking coverage for hand and finger positions. These sensors may be linked to a central processing system that merges data from all sensors, aligning hand positions with physical cockpit controls. This setup may include a calibration system that precisely aligns sensor data with cockpit layouts, and customizable algorithms that may adjust to various cockpit configurations, which may make the MCH system adaptable and accurate for different training scenarios.

In an example embodiment, the Automatic Tracking Setup (ATS) may provide a solution for seamless positional calibration within virtual and mixed-reality environments. The ATS may include an array of tracking sensors to establish a coordinate space and a computing unit that synchronizes sensor data with the virtual environment. Unique visual codes within the environment may enable accurate spatial orientation, while real-time positional correction may help ensure consistent accuracy. The ATS user interface may simplify the initial setup and support ongoing adjustments, enabling smooth and accurate integration of virtual and real spaces.

In an example embodiment, the Drone Remote Training (DRT) system may leverage the MRS platform to deliver an immersive, real-time drone operation experience. The DRT may include a mixed reality headset that streams video from a drone equipped with a camera and mixed reality module, allowing users to operate the drone remotely with a realistic first-person perspective. This system may include a robust network connection for seamless transmission of control signals and video data between the drone and the MRS. Additionally, a synchronization mechanism may align the user's head movements with the drone's camera orientation, enhancing the realism of the first-person view and providing a rich training experience that bridges simulation and real-world drone operation.

To illustrate the systems and methods described herein, specific hardware has been used. It will be understood that the systems and methods described herein may also be implemented in other hardware and software. For example, FPGAs, GPUs, and/or other specific hardware may be replaced with other hardware such as one or more processors, digital logic, other programable logic, Application-Specific Integrated Circuits (ASICs)

One or more elements or aspects or steps, or any portion(s) thereof, from one or more of any of the systems and methods described herein, may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display

Finally, the algorithms and displays presented herein are not inherently related to any particular computer or other apparatus. Various general-purpose systems may be used with programs in accordance with the teachings herein, or it may prove convenient to construct more specialized apparatus to perform one or more of the method steps. The structure for a variety of these systems will be discussed in the description below. It will be appreciated that a variety of programming languages may be used to implement the teachings of the invention as described herein

The figures and the following description describe certain embodiments only by way of illustration One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable, similar or similar reference numbers may be used in the figures to indicate similar or similar functionality.

The foregoing description of the embodiments of the present invention has been presented for illustration and description purposes. It is not intended to be exhaustive or to limit the present invention to the precise form disclosed. Many modifications and variations are possible in light of the above teaching. It is intended that the scope of the present invention be limited not by this detailed description but rather by the claims of this application. As will be understood by those familiar with the art, the present invention may be embodied in other specific forms without departing from the spirit or characteristics thereof. Likewise, the particular naming and division of the modules, routines, features, attributes, methodologies, and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies,

“and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable Module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based on design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C.” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A Modular Reconfigurable Simulator (MRS) system for flight training, comprising:
a Core Module (CM) with a user seat;
a plurality of interchangeable Instrumental Modules (IM) designed to replicate cockpit control interfaces of various aircraft types, including fixed-wing, rotary-wing, and drones;
a mechanism for easily exchanging each of the plurality of interchangeable Instrumental Modules (IM) by a user to transform the MRS to simulate different aircraft types;
integrated support for Virtual and Mixed Reality headsets to provide immersive simulation environments; and
a computing unit containing software to recognize and integrate the plurality of interchangeable Instrumental Modules (IM) with a virtual model of an aircraft cockpit,
wherein each Instrumental Module (IM) includes a set of controls corresponding to specific aircraft functions and a unique identification system for automatic recognition and configuration by the computing unit.

2. The MRS system of claim 1, further comprising an automatic hardware setup (AHS) includes custom printed circuit boards (PCBs) within each IM, allowing for automatic detection and configuration of connected IMs to the core module.

3. The MRS system of claim 1, further comprising a mixed reality simulator architecture (MSA), including a set of specific computer hardware components and algorithms to optimize performance of Virtual Reality and Mixed Reality (VR/MR) simulations.

4. The MRS system of claim 1, wherein cockpit motion compensation (CMC) is facilitated by integrated hardware sensors and algorithms within a Virtual Reality and Mixed Reality (VR/MR) headset or simulator chassis, compensating for alignment discrepancies between virtual and real-world environments.

5. The MRS system of claim 1, further including a virtual reality cockpit handtracking (VCH) technology, enabling users to interact with virtual cockpit controls in a Virtual Reality (VR) environment through precise hand and finger tracking.

6. The MRS system of claim 1, further comprising a mixed reality cockpit handtracking (MCH), allowing for accurate operation of physical cockpit controls within a mixed reality environment.

7. The MRS system of claim 1, incorporating realistic cockpit lighting (RCL), a system of separately controllable LEDs and algorithms to simulate various cockpit lighting conditions based on Virtual Reality and Mixed Reality (VR/MR) scenarios.

8. The MRS system of claim 1, equipped with an automatic tracking setup (ATS) system for accurate alignment of virtual and physical spaces.

9. The MRS system of claim 1, adaptable for drone remote training (DRT), allowing users to control and experience real-time flight scenarios of drones through a mixed reality interface.

10. A mixed reality simulation architecture comprising:
a computer hardware system configured to run a mixed-reality simulation;
a virtual reality (VR) headset equipped with a stereo camera module;
a software framework configured to process real-time video streams captured by the VR headset and render virtual environments using a graphical processing unit (GPU) of the computer hardware system;
an algorithm set for optimizing color dynamic range, image debayering, denoising, and sharpening in video streams of the VR headset;
a latency compensation mechanism that utilizes direct memory access of the computer hardware system to reduce processing delays; and
an image compositing module that combines VR environment data and processed video streams to create a mixed reality output.

11. The mixed reality simulation architecture of claim 10, wherein the stereo camera module in the VR headset is configured to capture depth information, enhancing real-time spatial accuracy in the mixed reality output.

12. The mixed reality simulation architecture of claim 10, further comprising real-time feedback sensors embedded within the VR headset, configured to adjust image brightness and contrast based on ambient lighting conditions detected in the real environment.

13. The mixed reality simulation architecture of claim 10, wherein the latency compensation mechanism includes an adjustable time-warping algorithm, which modifies image rendering timing to accommodate user head movements and reduce perceived lag.

14. The mixed reality simulation architecture of claim 10, wherein the image compositing module is further configured to apply virtual overlays corresponding to cockpit controls or instrumentation in response to user interactions detected by the VR headset.

15. The mixed reality simulation architecture of claim 10, wherein the algorithm set includes a color correction algorithm specifically calibrated for various lighting conditions, such as day, dusk, and night, to maintain realistic visual fidelity across different simulated environments.

16. A Virtual Reality Cockpit Handtracking (VCH) system, comprising:
an array of optical sensors for detecting hand and finger movements;
a processing unit configured to create a 3D model of user's hand movements in real-time;
a software application capable of interpreting the 3D model to simulate user interactions with virtual cockpit controls;
an integration interface for connecting the handtracking system with various virtual reality simulation environments; and
a machine learning algorithm to improve hand and finger tracking accuracy based on user interactions.

17. The Virtual Reality Cockpit Handtracking (VCH) system of claim 11, further comprising haptic feedback mechanisms integrated with the optical sensors, providing tactile responses to the user based on virtual cockpit interactions.

18. The Virtual Reality Cockpit Handtracking (VCH) system of claim 11, wherein the machine learning algorithm is trained on a dataset of aviation-specific hand movements, enhancing tracking accuracy for common cockpit gestures.

19. The Virtual Reality Cockpit Handtracking (VCH) system of claim 11, wherein the software application is configured to dynamically adjust the sensitivity of hand and finger movement detection based on the type of control interaction, such as toggles, buttons, or levers.

20. The Virtual Reality Cockpit Handtracking (VCH) system of claim 11, further comprising a calibration module that automatically adjusts the 3D model of the user's hand based on initial setup parameters, ensuring alignment with cockpit controls across various virtual reality environments.
